(19) United States
(12) Patent Application Publication
(10) Pub. No.: US 2023/0291491 A1
(43) Pub. Date: Sep. 14, 2023

(54) COMMUNICATION OF OPTICAL CODES BETWEEN DEVICES

(71) Applicant: INTELLIJOINT SURGICAL INC., KITCHENER (CA)

(72) Inventors: JOSEPH ARTHUR SCHIPPER, KITCHENER (CA); ANDRE NOVOMIR HLADIO, WATERLOO (CA)

(21) Appl. No.: 18/131,565

(22) Filed: Apr. 6, 2023

Related U.S. Application Data
(63) Continuation of application No. PCT/CA2021/051399, filed on Oct. 6, 2021.
(60) Provisional application No. 63/089,362, filed on Oct. 8, 2020.

(51) Int. Cl. H04J 14/00; H04B 10/116

(52) U.S. Cl. CPC H04J 14/005; H04B 10/116

(57) ABSTRACT

Systems, devices, methods and techniques are provided to improve communication of data over a distance without using radio waves using a sequence of frames comprising optical codes. In one embodiment, the frames include multiple channels where each channel comprises the same optical codes but in a different order of a code sequence. In one embodiment, at a receiving device, a progress indicator is provided that is responsive to the decoding of the optical codes. In one embodiment, the progress indicator is indicative of frames (codes) read. In one embodiment, the progress indicator is a timer. In one embodiment, at a sending device, controls are provided for user input to selectively communicate frames (codes). In one embodiment, at a sequence generator, data is segmented to define frames to optimize communications.

### CROSS-REFERENCE

This application is a continuation of PCT Application No. PCT/CA2021/051399, filed Oct. 6, 2021 and entitled, “Communication of Optical Codes between Devices”, the entire contents of which are incorporated herein by reference. The PCT Application No. PCT/CA2021/051399 claims a benefit of U.S. Provisional Application No. 63/089,362 filed Oct. 8, 2020 and entitled, “Communication of Optical Codes between Devices”, the entire contents of which are incorporated herein by reference.

### FIELD

This disclosure relates to communication of information and in particular to communicating information over a distance using optical codes, without using radio waves.

### BACKGROUND

It is often desired to communicate information from one device to another without physically coupling the devices. In some scenarios, use of a wireless signal comprising radio waves is undesirable. Optical codes are transmissible, over a distance, from one device to another where a first (sending) device displays an optical code and a second (receiving) device receives the code via an image sensor or camera and decodes the information encoded by the optical code. Optical codes are transmissible through light-transmissive mediums such as air and water, as well as through empty space (e.g. a vacuum).

Optical codes can take different forms. Once such form is a two-dimensional (2D) barcode, such as a QR Code® (a trademark of Denso Wave Incorporated), which encodes information in horizontal and vertical directions. While a single 2D barcode can encode a significant amount of information, more information may be desired to be communicated than may be encoded in one code. The information capacity of an instance of a single optical code such as a 2D barcode may be constrained to meet requirements of scale and/or resolution, standards defined for the type of code, etc. Such standards can be defined so that the optical code can be read at a specified distance, and/or by devices having limited reading capabilities.

Displaying a sequence of optical codes such as in a series of frames of a video or other data structure has been proposed. Such a burst of codes can increase the amount of information sent. It also obviates the need for a user to send (or a user to receive) multiple codes separately, one by one. However, there is a need to improve the encoding and/or communication of a sequence of optical codes.

### SUMMARY

In accordance with embodiments, systems, methods and techniques are described herein to communicate information via sequences of optical codes.

According to a broad aspect, the present disclosure describes a computer method comprising: encoding data into a plurality of optical codes in an optical code sequence; generating a plurality of frames for presenting in a frame sequence, wherein: the plurality of frames comprises at least two channels to present the optical code sequence; and each channel presents the same optical codes in the optical code sequence, but in a different order of the optical code sequence; and providing the frame sequence for display.

The different order of the codes may be selected to optimize a combination of: transmission duration and transmission predictability.

Generating the plurality of frames may include generating identification features to visually identify and distinguish the at least two channels. The frames may be generated as components of a video file or a GIF.

Providing the frame sequence for display may comprise communicating the frames to a sending device configured to display the frames for receiving by a receiving device a distance from the sending device, without using radio waves to communicate the frames between the sending device and the receiving device. Communicating the frames to a sending device may comprise communicating the frames via email to the sending device.

According to another broad aspect, the present disclosure describes a computer method comprising: (a) receiving, via an image sensor, a sequence of images from a sending device displaying frames in a frame sequence comprising at least two channels of optical codes; (b) identifying, from the images, optical codes from each of the at least two channels; (c) decoding and storing the optical codes, wherein duplicate optical codes are discarded; and (d) performing steps a, b and c until a completeness metric is achieved.

Identifying the optical codes from each channel may comprise localizing a respective optical code in a respective image using image processing. Localizing may comprise determining a location of identification features in the respective image. Localizing may be based on a location of identified optical codes in a previous image to the respective image.

The optical codes may be defined having a code sequence and, in the frames, each channel may comprise the same optical codes but in a different order of the code sequence. The different order of the code sequence is selected to optimize a combination of: transmission duration and transmission predictability.

Receiving via the image sensor may comprise receiving from a sending device the frames at a receiving device over a distance, without using radio waves to communicate the frames between the sending device and the receiving device.

According to another broad aspect, the present disclosure describes a computer method comprising: receiving, via an image sensor, a sequence of images from a sending device displaying frames comprising a sequence of optical codes, each optical code comprising an optical code index; decoding the optical codes and recording optical code indices of the codes that are decoded; and providing for display a progress indicator responsive to the optical code indices of the codes that are decoded.

The method may further comprise providing for display a second indicator indicating a location of a last decoded optical code within the sequence of optical codes. The second indicator may be one of: a numerical display of a last read optical code index; and a graphical indicator along a graphical element representing the sequence of optical codes.

The progress indicator may be one or both of: a numerical display of indices of unread optical codes; and a graphical element in which read and unread codes are visually distinguishable.

Each frame may comprise a frame index, each frame may comprise a plurality of optical codes of the optical code sequence, and providing for display a progress indicator may include providing for display a progress indicator which indicates at least one frame index of at least one frame containing an optical code that was not decoded.

According to another broad aspect, the present disclosure describes a computer method comprising: receiving, via an image sensor, a sequence of images from a sending device displaying frames comprising a sequence of optical codes, each optical code comprising an optical code index; decoding the optical codes and recording the indices of decoded optical codes; and providing for display a progress indicator of transmission time of the optical codes.

The progress indicator may be a countdown timer indicating an amount of time remaining to decode the optical codes. The countdown timer may be responsive to each optical code remaining to be received and decoded without error. The countdown timer may be responsive to a projected number of errors.

The method may further comprise calculating the frequency of image transitions, and the countdown timer may be responsive to the frequency as calculated.

According to another broad aspect, the present disclosure describes a computer method comprising: generating a sequence of frames, wherein: each frame comprises an optical code; and each frame has an index; and providing the sequence of frames for display both as a video or animation and as individual static frames.

The frames may comprise a GIF, and providing the sequence of frames may comprise sending a communication including: the GIF as the video; and static images of the frames with indices.

According to another broad aspect, the present disclosure describes a computer method comprising: receiving a sequence of frames for visual display; displaying the sequence of frames to communicate the frames to a receiving device over a distance, without using radio waves to communicate the sequence to the receiving device; and responsive to user input while communicating the frames, performing one of: selecting a particular frame to be communicated; pausing the video; and changing the speed of video playback.

According to another broad aspect, the present disclosure describes a computer method comprising: receiving data to be encoded; determining segmentation parameters to segment the data into a plurality of data segments, each data segment to be encoded in a single respective optical code of a plurality of optical codes, and wherein the segmentation parameters are determined to minimize a processing time by a receiving device to receive and/or decode the optical codes; generating a sequence of frames comprising the optical codes; and providing the sequence of frames for display by a sending device to communicate the sequence of frames to the receiving device.

The segmentation parameters may include: a data capacity of each optical code; and error correction/redundancy information.

The segmentation parameters may be further selected based on: display device performance specifications; and camera/receiver specifications.

Determining segmentation parameters may comprise performing a simulation to determine a minimum read time based on candidate segmentation parameters.

In any of the method aspects, data encoded in the optical codes may comprise a digital signature certifying the data.

It will be understood by a person of ordinary skill in the art that any of the method aspects may be performed by a computing device comprising a processor and a storage device storing instructions for execution by the processor to configure operations of the computing device to perform any of the methods. It will be further understood that non-transitory storage media (e.g. tapes, discs, integrated circuit devices such as memory devices, drives, etc.) may store instructions for execution by a processor to configure operations of a computing device to perform any of the methods.

### BRIEF DESCRIPTION OF THE DRAWINGS

FIG. 1 is a front view of a system for communicating optical codes over a distance from a sending device to a receiving device without using radio waves for the communication.

FIGS. 2A and 2B illustrate exemplary frames of an optical sequence, with two optical codes displayed in each frame.

FIG. 3A is a flowchart diagram which illustrates an exemplary method for presenting a sequence of frames.

FIG. 3B is a flowchart diagram which illustrates an exemplary method for receiving a sequence of frames.

FIGS. 4A, 4B, and 4C are tables which show sequences of frames communicated in multiple channels of a sequence of frames, with optical codes communicated in reverse order in different channels.

FIGS. 5A and 5B are tables which show sequences of frames communicated in multiple channels of a sequence of frames, with optical codes communicated in offset order in different channels.

FIGS. 6A and 6B are tables which show sequences of frames communicated in multiple channels of a sequence of frames, with optical codes communicated in different orders in each channel.

FIGS. 7, 8A, 8B, 8C, 8D illustrate exemplary localization of optical codes in images based on identification features.

FIGS. 9A and 9B illustrate an exemplary technique of identifying a region of interest in an image.

FIG. 10 is a flowchart diagram which illustrates an exemplary method for providing feedback on frame status.

FIGS. 11A and 11B illustrate exemplary user interfaces for providing feedback on frame status.

FIG. 12 is a flowchart diagram which illustrates an exemplary method for altering display of a frame sequence in response to user input.

FIG. 13 is an exemplary user interface for altering display of a frame sequence in response to user input.

FIG. 14 is a flowchart diagram which illustrates an exemplary method for evaluating whether received data should be used.

FIG. 15 is an exemplary interface for evaluating whether received data should be used.

FIGS. 16A, 16B, 16C, 16D, 16E, and 16F illustrate exemplary user interfaces for providing feedback on frame status and communication status.

FIG. 17 is a flowchart diagram which illustrates an exemplary method for generating a sequence of frames comprising optical codes.

FIG. 18 is a flowchart diagram which illustrates an exemplary method for determining segmentation parameters for encoding an optical code sequence.

FIG. 19 is a flowchart diagram which illustrates an exemplary method for generating and providing a sequence of frames for display.

FIG. 20 is a flowchart diagram which illustrates an exemplary method for generating and providing a sequence of frames for display, and for receiving and decoding the sequence of frames.

FIGS. 21A and 21B are schematic diagrams of exemplary networks and systems in which the embodiments described herein can be implemented.

### DETAILED DESCRIPTION

The description herein details several exemplary embodiments. One skilled in the art will appreciate that it is within the scope of the present disclosure to combined individual embodiments with other embodiments as appropriate. The followings terms are used herein:

Optical code: static instance of something that an image sensor or camera can read (e.g. a 2D barcode such as a QR Code). Information can be encoded in the optical code spatially, such that light from different regions of the code will have differing brightness and/or wavelength. In the example of a black and white barcode, light from black regions of the code will have significantly lower brightness than light from white regions of the code, such that the black and white regions can be used to encode binary data.

Frame: one image in a sequence of images (in some examples, one frame contains a representation of one optical code, and in other examples, one frame can contain representations of multiple optical codes).

Sequence: a set of multiple frames. A sequence can be displayed or received as a video, animation, or temporal arrangement of individual images.

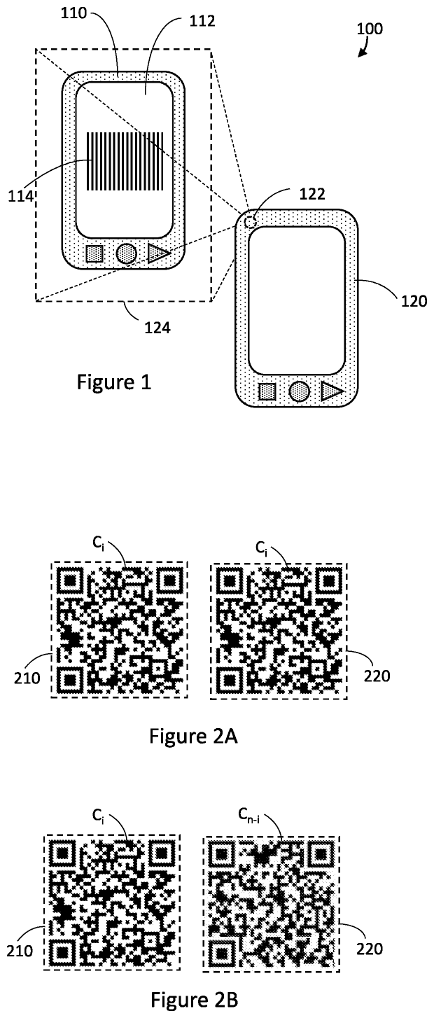

FIG. 1 is a front view of a system 100 in accordance with an exemplary implementation. System 100 includes at least a sending device 110 and a receiving device 120. Devices 110 and 120 may comprise computing devices having a processor and a storage device where the storage device stores instructions which when executed by the processor configure operations of the computing device.

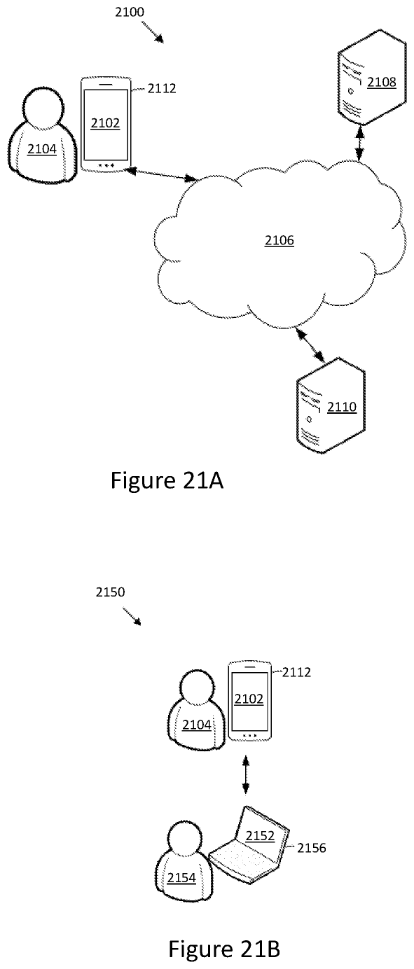

Sending device 110 includes a display 112 which can output (display, present visually) optical codes or sequences of optical code frames. In FIG. 1, display 112 is shown as outputting an optical code 114. Sending device 110 can include, or be communicatively coupled to, a sequence generator. The sequence generator receives or generates data to be transmitted optically, and generates a sequence of optical codes, the optical codes having the data to be transmitted encoded therein. The sequence of codes could be formatted for example as a video or animation file (e.g. AVI, MPG, GIF, BMP or any other appropriate file type which supports a sequence of image frames). In some examples, at least one processor in sending device 110 could act as a sequence generator. In other examples, sending device 110 could be communicatively coupled to a sequence generator over a network (discussed later with reference to FIGS. 21A and 21B).

Receiving device 120 includes an image sensor 122 (shown in dashed lines because is it positioned on a rear of receiving device 120). Image sensor 122 could be a camera found in mobile devices like cellular telephones and smartphones, for example. Image sensor 122 can capture image data over a field of view 124. Optical code 114 can be positioned within field of view 124, such that image sensor 122 can capture image data including a representation of the optical code 114, and receiving device 120 can decode the optical code 114 in the image data.

In FIG. 1, sending device 110 is shown as being completely positioned within field of view 124. However, this is not necessarily required. Rather, only a portion of sending device 110 may be positioned in field of view 124, as long as a sufficient amount of optical code 114 is positioned within field of view 124 to enable receiving device 120 to decode the optical code 114.

In the example of FIG. 1, sending device 110 and receiving device 120 are both illustrated as mobile devices (e.g., cellular phones, smartphones, tablets, PDAs, or similar). However, in practice sending device 110 and receiving device 120 could be any appropriate device, including for example personal computers, laptops, or purpose-built code communication devices (such as barcode scanners). Further, image sensor 122 is shown as being built into receiving device 120, but this is not necessarily required. For example, image sensor 122 could be a separate device which is communicatively coupled to receiving device 120. For example, image sensor 122 could be, or be part of, a camera which plugs into or otherwise communicates with (e.g. wirelessly) receiving device 120.

In some implementations, sending device 110 and receiving device 120 could be capable of both sending and receiving optical codes as described herein, such that the roles of the device could be reversed, with device 110 acting as a receiving device, and device 120 acting as a receiving device.

References throughout this disclosure to a “sending device” and a “receiving device” can refer to sending device 110 and receiving device 120, respectively, but can also refer to devices which serve similar roles and achieve similar functionality. Further, acts described herein as being performed by a sending device or a receiving device can be performed by components of these devices. For example, acts of determining, calculating, encoding, decoding, reading etc. can be performed by at least one processor of the sending device or the receiving device. Further, acts of communicating, presenting, displaying, sending, or outputting optical codes or frames can be performed by a display of the sending device. Further still, acts of capturing, receiving, etc. optical codes or frame can be performed by an image sensor or camera of the receiving device. In addition, acts performed by at least one processor of any of the devices herein can be caused by instructions stored in a non-transitory processor-readable storage medium of said device. For example, a non-transitory processor-readable storage medium of a sending device can have instructions stored thereon which, when executed by at least one processor of the sending device, cause the sending device to perform actions dictated by the instructions. Similarly, a non-transitory processor-readable storage medium of a receiving device can have instructions stored thereon which, when executed by at least one processor of the receiving device, cause the receiving device to perform actions dictated by the instructions.

Issues may arise when communicating successive frames of optical codes. For example, a receiving device may not properly receive and decode each of the optical codes. Communication can often be one way, such that the receiving device does not provide communication signals back to the sending device. One manner to address a missed optical code is to repeat a communication. As one example, frames can be automatically communicated in a loop, starting over at the beginning each time the end of the loop is reached. As another example, frames can be communicated using discrete attempts, where a user manually restarts communication each time. Repeated attempts in loops or otherwise may be undesirable. In particular, repeated attempts can be time consuming and frustrating for users, and can consume additional power.

### Two or More QR Codes at the Same Time (Plurality of Channels)

The present disclosure provides means to communicate information encoded to a number (n) of optical codes (C) with code index (i)=1, 2, . . . n referencing one code (Cᵢ). Note that the code index (i) can be different from a frame index of a sequence.

FIGS. 2A, 2B, 3A-3B, 4A-4C, 5A-5B, 6A-6B, 7, and 8A-8D discussed below illustrate implementations where multiple optical codes can be transmitted simultaneously, to improve the chances that all of the optical codes are properly received and decoded.

FIG. 2A illustrates one frame of an optical sequence communicated by a sending device, where two copies of optical code Cᵢ for the frame are displayed simultaneously. This can be performed for each frame of an optical code sequence, such that two (or more) copies of an optical code are displayed each frame. Each spatially separated region where one optical code is presented at a time can be considered as a different “channel”. In the case of FIG. 2A, the left region where a sequence of singular optical codes is presented can be considered as a first channel (labelled as 210), and the right region where a sequence of singular optical codes is presented can be considered as a second channel (labelled as 220). Although FIG. 2A illustrates two channels, any appropriate number of channels is possible.

Such an implementation advantageously can improve accuracy, by presenting optical codes in duplicate so that if one optical code is not readable, a duplicate of the code may be, and thus the code can still be read. This is particularly useful when one of the optical code copies is occluded, such as by an object coming between the sending device and the reading device.

However, there are cases where an entire frame from the sending device may not be properly read or decoded by the receiving device. For example, if the sending device or receiving device is moved or shaken during a frame, an entire image captured during the frame by the receiving device may be blurry. Consequently, the image may not provide sufficiently distinct representations of the optical codes for the receiving device to properly decode the optical codes, even if the optical codes are presented in duplicate. As another example, if an optical code in a given frame is particularly complex or difficult to decode, and the receiving device is decoding in real time (i.e. without a buffer), the receiving device may drop or not decode the optical code. Presenting multiple copies of the optical code simultaneously would not resolve this issue, but would rather compound it by adding additional complexity to the decoding process.

FIG. 2B illustrates an exemplary solution to this issue. FIG. 2B illustrates one frame of an optical sequence communicated by a sending device, where multiple optical codes are communicated simultaneously in respective channels 210 and 220. Although FIG. 2B illustrates two channels, additional channels may be included, representing additional optical codes. A difference between the implementations of FIGS. 2A and 2B is that in FIG. 2B, the optical codes presented simultaneously are different. In particular, for the frame illustrated in FIG. 2B, optical code Cᵢ is presented in channel 210, and optical code Cₙ₋ᵢ is communicated in channel 220. Further, this can be applied for most (though not necessarily all as discussed later) frames communicated. Each channel can present the same sequence of optical codes, but can present them in different order.

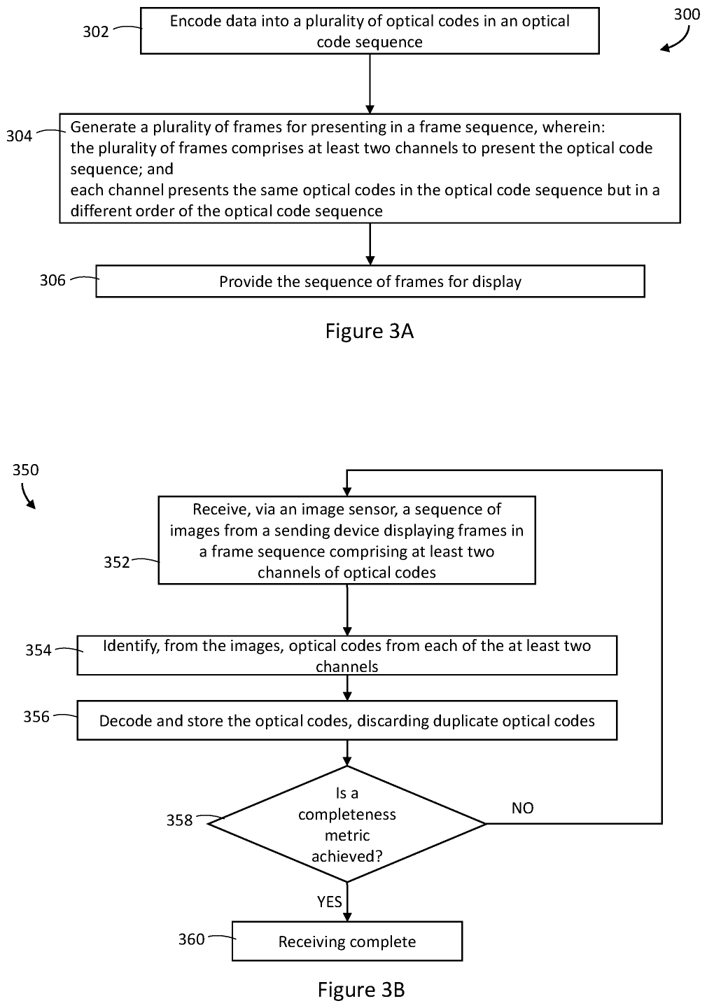

FIG. 3A is a flowchart diagram which illustrates an exemplary method 300 for presenting a sequence of frames as discussed regarding FIG. 2B. Method 300 includes at least acts 302, 304, and 306, though additional acts can be added as appropriate for a given application. The sequence generator discussed can be for example a processor included in the sending device, or a processor in a computing device physical separate from but communicatively coupled to the sending device.

In act 302, data is encoded by a sequence generator into a plurality of optical codes in an optical code sequence.

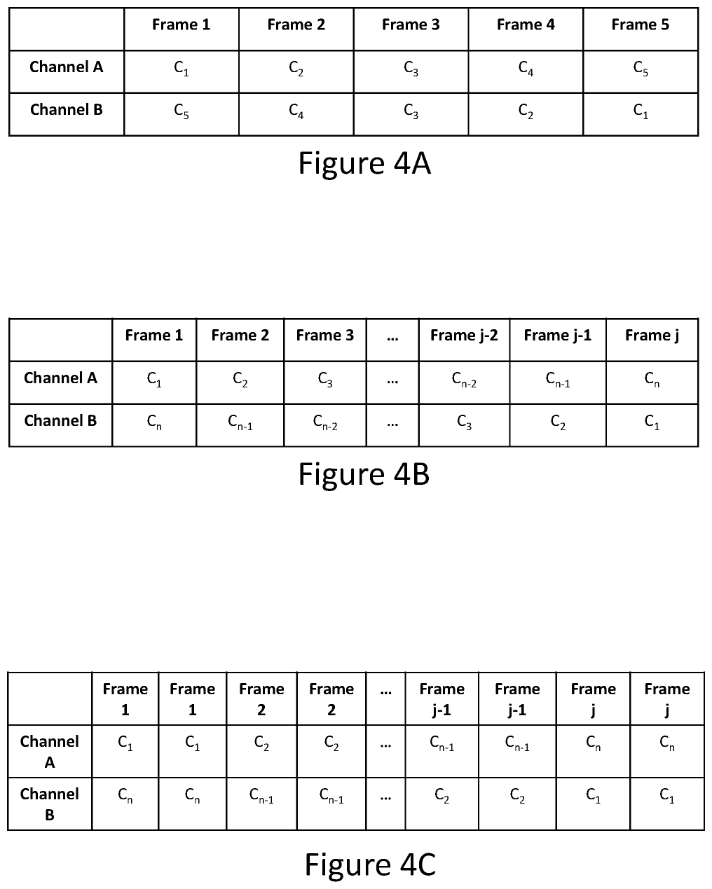

In act 304, the sequence generator generates a plurality of frames for presenting in a frame sequence, wherein the plurality of frames comprises at least two channels to present the optical code sequence, and each channel presents the same optical codes in the optical code sequence but in a different order of the optical code sequence. Several exemplary techniques for generating the plurality of frames, and for arranging different optical code orders in each channel, are discussed below with reference to FIGS. 4A-4C, 5A-5B, and 6A-6B.

In act 306, the sequence generator provides the sequence of frames for display. This could include for example a processor of the sending device providing the frame sequence to a display of the sending device for output. As another example, this could include a sequence generator separate from the sending device providing the sequence of frames to the sending device, for display by the sending device (e.g., the sequence of frames could be emailed to the sending device, for display by the sending device to communicate the code to a receiving device optically without using radio waves).

FIG. 3B is a flowchart diagram which illustrates an exemplary method 350 for receiving a sequence of frames as discussed regarding FIG. 2B. For example, method 350 can be performed to receive a sequence of frames displayed per method 300 in FIG. 3A. Method 350 includes at least acts 352, 354, 356, 358, and 360, though additional acts can be added as appropriate for a given application. Generally, the acts of method 350 are described as being performed by a processor and/or a non-transitory processor readable storage medium included in the receiving device. However, the acts of method 350 can also be performed by a processor and/or non-transitory processor-readable medium which are communicatively coupled to, but not necessarily include in, the receiving device.

In act 352, a sequence of images is received by a receiving device from a sending device displaying frames in a frame sequence comprising at least two channels of optical codes. The receiving device and the sending device can be similar to receiving device 120 and sending device 110, respectively, discussed with reference to FIG. 1. Several exemplary techniques for optical codes can be arranged in each channel are discussed below with reference to FIGS. 4A-4C, 5A-5B, and 6A-6B.

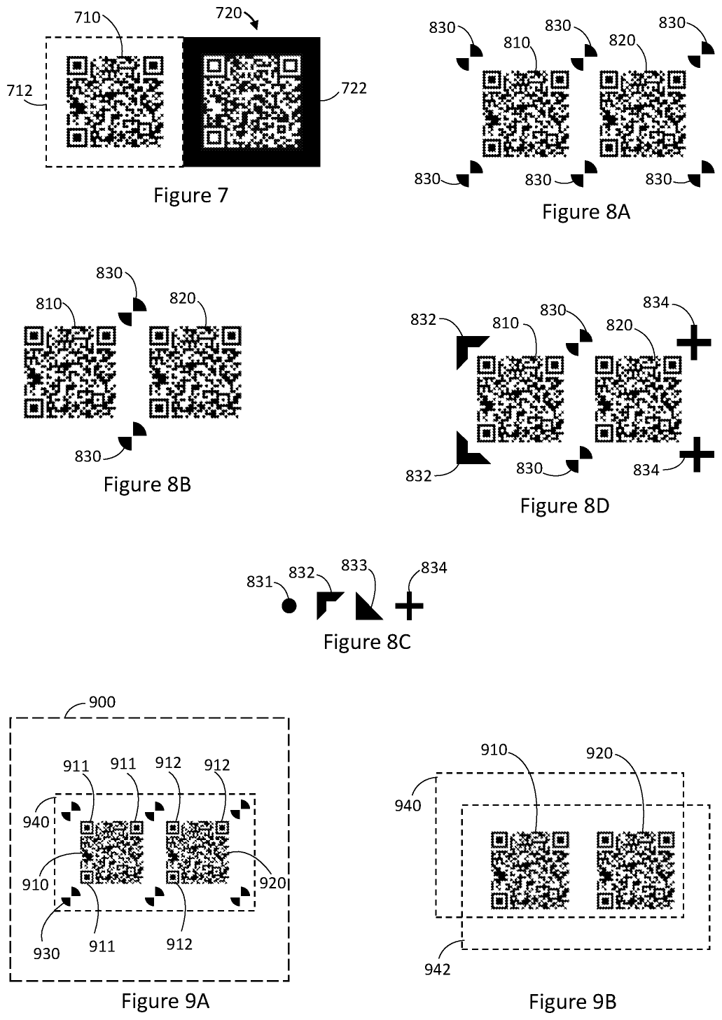

In act 354, optical codes from each of the at least two channels are identified. For example, a processor of the receiving device could perform image processing on images received by the image sensor, to identify and/or localize optical codes in each image (for example delineating multiple optical codes from each other, or determining a region of interest for detailed image processing). Exemplary techniques for identifying, detecting, and localizing optical codes and regions of interest in an image are discussed later with reference to FIGS. 7, 8A-8D, and 9A-9B.

In act 356, optical codes identified in act 354 are decoded and stored. For example, a processor of the receiving device can perform image processing on at least a region of images from the image sensor, to read/decode the data encoded in each optical code, and store data from the decoded optical codes, for example on a non-transitory processor-readable storage medium on the receiving device. When an optical code is at least partially decoded, the processor can determine whether that optical code has already been previously decoded and stored, for example by checking an index of the optical code against indices of already decoded and stored optical codes. Duplicate codes which have already been decoded can be discarded (keeping the originally decoded code), or can be used to overwrite the previously decoded code (for example if the subsequently decoded code is decoded with greater accuracy).

In act 358, a determination as made as to whether a completion metric is achieved. For example, a processor of the receiving device could determine if every optical code in the sequence was properly received. This could entail for example comparing the number of correctly received optical codes against an expected number of optical codes. As another example, data may be compressed and encoded in the sequence of optical codes, along with redundancy data. In such an example, the completion metric could be the receipt of all unique data, which may occur even if not all optical codes are received and decoded (for example if certain optical codes contain only redundancy data).

If it is determined in act 358 that the completion metric is not achieved, the method 350 can return to act 352, to receive the frame sequence again (i.e., try another playback loop). If it is determined in act 358 that the completion metric is achieved, then the optical code sequence is properly received and transfer of the optical code sequence is complete, as in act 360.

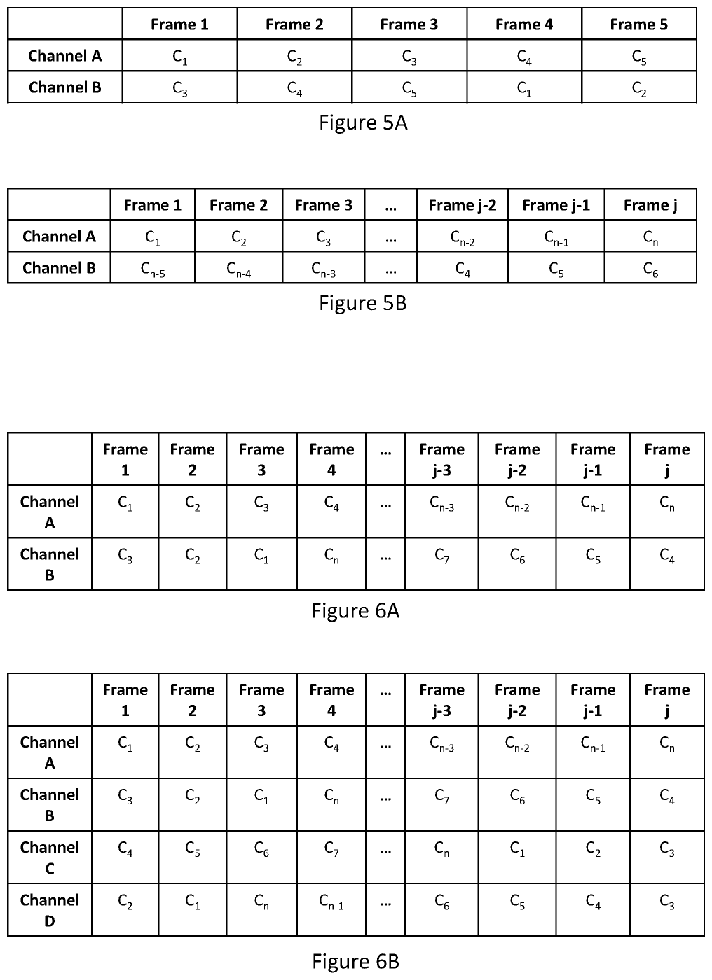

By presenting multiple channels with the same sequence of optical codes, but in a different order, copies of each optical code will be separated temporally, such that even if one frame is dropped, missed, not read, not decoded, not received, or otherwise erroneous, another copy of each optical code in the frame should be included in another frame somewhere in the frame sequence. This improves the chances that each optical code will be received and decoded correctly. Example changes of order could include for example reversing an order of communication of optical codes between channels as discussed with reference to FIGS. 4A-4C, communicating optical codes with a delay or offset as discussed with reference to FIGS. 5A-5B, or combinations of order changes of optical codes as discussed with reference to FIGS. 6A-6B.

A sequence of optical codes communicated in channel 220 can be reversed relative to the order optical codes are communicated in channel 210. An exemplary sequence of 5 optical codes C₁, C₂, C₃, C₄, and C₅ communicated in 5 frames is illustrated in FIG. 4A. FIG. 4A is a table which shows a sequence of frames communicated, and which optical codes are communicated in each channel of each frame. In a first Channel A, the optical codes are communicated in the order C₁, C₂, C₃, C₄, then C₅. In a second Channel B, the optical codes are communicated in the order C₅, C₄, C₃, C₂, then C₁. In this way, even if frame 1 is not properly received, codes C₁ and C₅ can still be read from frame 5. Similarly, even if frame 4 is not properly received, codes C₂ and C₄ can still be read from frame 2, and so forth.

This concept can be extended to an indefinite number of frames, as illustrated in FIG. 4B. FIG. 4B is a table which shows a sequence of frames communicated, and which optical codes are communicated in each channel of each frame. A total number of frames j are presented, to communicate a total number of optical codes n. In channel A, the frame index (from 1 to j) matches the optical code index (from 1 to n), such that the sequence of optical codes C is presented in order. In channel B, on the other hand, the sequence of optical codes is presented in reverse order. Similar to FIG. 4A, even if a frame is not properly received, the optical codes within that frame can be read from another frame.

As can be seen in the example of FIG. 4A, when an odd number of frames is communicated, the middle frame (frame 3 in FIG. 4A) contains duplicates of the same optical code (C₃), and this optical code is not communicated in any other frame. Consequently, if this middle frame is not properly received, the optical code communicated therein will not be decoded. Further, if two frames which contain the same optical codes are not properly received, then those optical codes will not be decoded. Further ways to improve on this scheme and resolve these issues are discussed below.

Firstly, the scheme of FIGS. 4A and 4B can still be looped as described earlier if an optical code is not properly decoded. Compared to schemes in which different code channels are not presented, the scheme of FIGS. 4A and 4B will significantly reduce the amount of non-decoded optical codes, and thus will reduce the amount of looping required. To further reduce looping, each frame can be repeated any appropriate number of times, to further reduce the probability of optical code not being decoded in this first place. This is illustrated in FIG. 4C, which is a similar table to FIG. 4B. In FIG. 4C, each frame is communicated twice, such that even if a frame is not properly received, there will be another frame communicated which contains the optical codes in said frame. Further, combined with the difference of optical code communication order between channels A and B, most optical codes will be communicated four times, such that four frames would need to be not properly received for an optical code to not be decoded. This concept can be expanded to repeat each frame more than twice, to increase robustness.

Further, each frame does not need to be repeated an equal number of times. Rather, frames which are more likely to be communicated erroneously can be repeated more times. For example, the middle frame in an odd numbered sequence (e.g. Frame 3 in FIG. 4A) could be the only frame repeated, since the codes in this frame are not represented in other frames. As another example, a disruption like movement of the sending device and/or the receiving device can span across multiple frames. In the frames nearest to the middle of the sequence, the represented optical codes are more closely grouped together. As an example, in FIG. 4A, optical codes C₁ and C₅ are communicated 3 frames apart, whereas optical codes C₂ and C₄ are communicated 1 frame apart. Consequently, a disturbance which spans multiple frames is more likely to prevent optical codes C₂ and C₄ from being decoded, as opposed to optical codes C₁ and C₅. To address this, the frames near the middle of the sequence could be repeated to reduce the chances of these optical codes not being decoded.

A sequence of optical codes communicated in channel 220 can be communicated with an offset or delay relative to the sequence of optical codes communicated in channel 210. An exemplary sequence of 5 optical codes C₁, C₂, C₃, C₄, and C₅ communicated in 5 frames is illustrated in FIG. 5A. FIG. 5A is a table which shows a sequence of frames communicated, and which optical codes are communicated in each channel of each frame. In a first Channel A, the optical codes are communicated in the order C₁, C₂, C₃, C₄, then C₅. In a second Channel B, the optical codes are communicated with a forward offset of 2 frames, in the order C₃, C₄, C₅, C₁, then C₂. In this way, even if frame 1 is not properly received, codes C₁ and C₃ can still be read from frames 3 and 4. Similarly, even if frame 4 is not properly received, codes C₁ and C₄ can still be read from frames 1 and 2, and so forth.

This concept can be extended to an indefinite number of frames, as illustrated in FIG. 5B. FIG. 5B is a table which shows a sequence of frames communicated, and which optical codes are communicated in each channel of each frame. A total number of frames j are presented, to communicate a total number of optical codes n. In channel A, the frame index (from 1 to j) matches the optical code index (from 1 to n), such that the sequence of optical codes C is presented in order. In channel B, on the other hand, the sequence of optical codes is presented with a delay of 6 frames. Similar to FIG. 5A, even if a frame is not properly received, the optical codes within that frame can be read from other frames.

Similar to as discussed with reference to FIGS. 4A-4C, the scheme of FIGS. 5A and 5B can still be looped if an optical code is not properly decoded, though looping will be reduced thanks to the presentation of different codes in multiple channels. Further, similar to as discussed with reference to FIG. 4C, each frame can be repeated any appropriate number of times, to further reduce the probability of the optical code not being decoded in this first place.

Reversing the order of communication of the optical codes in one channel can be combined with applying an offset or delay in the index of the presented optical codes, as shown in FIGS. 6A and 6B. FIG. 6A is another table which shows a sequence of frames communicated, and which optical codes are communicated in each channel of each frame. In the example of FIG. 6A, relative to the sequence of optical codes communicated in channel A, the sequence of optical codes communicated in channel B is reversed, then offset by three frames. This can provide further distinction between the sequences of frames communicated by both channels.

The scheme of FIG. 6A can be particularly useful when more than two channels of optical codes are presented. In a first subset of channels, optical codes could be communicated in forward order, and in a second subset of channels, optical codes could be communicated in reverse order. Any appropriate offsets could be applied to each channel in the first subset of channels, such that each channel in the first subset of channels communicates the sequence of optical codes in a different order. Similarly, any appropriate offsets could be applied to each channel in the second subset of channels, such that each channel in the second subset of channels communicates the sequence of optical codes in a different order. An example is shown in FIG. 6B, which illustrates another table which shows a sequence of frames communicated, and which optical codes are communicated in each of four channels A, B, C, and D in each frame. In the example of FIG. 6B, relative to the sequence of optical codes communicated in channel A, the sequence of optical codes communicated in channel B is reversed then offset by three frames, the sequence of optical codes communicated in channel C is in forward order then offset by three frames, the sequence of optical codes communicated in channel D is reversed then offset by two frames. The result is that each of channels A, B, C, and D communicate a unique sequence of optical codes, reducing overlap. Therefore, the chances that a given optical code is not included in any properly received frame is significantly reduced.

In the examples of FIGS. 4A-4C, FIGS. 5A-5B, and FIGS. 6A-6B, the indices and order of the optical codes is selected to increase the likelihood that the optical codes are received in a single communication of the frames, thereby increasing the speed (reducing duration), predictability, and/or reliability of the data transfer. That is, the indices and order of the optical codes is selected to optimize at least one or a combination of transmission speed (duration), transmission predictability, and/or transmission reliability, or other appropriate factors.

The number of simultaneously communicated codes (i.e. the number of channels) in a given application can be determined based on constraints such as display size, aspect ratio, resolution, refresh rate, in order to meet targets like size of optical codes, size of data unit in each code (e.g., size of each black or white “module” or “pixel” in a QR Code), space between optical codes, etc. In some embodiments, two simultaneously presented optical codes are appropriate to meet the constraints of typical smartphones, a type of mobile device.

Additionally, when discussing communication of optical codes in a sequence of frames, the frame rate of the sequence of the optical codes does not necessarily have to match the frame rate of a display of the sending device communicating the codes, or a frame rate of the image sensor which receives the optical codes (although they can match). Rather, the frame rate of the optical code sequence can be defined such that each frame is communicated for a specified length of time, regardless of the frame rate of said display or said image sensor. Because said display and said image sensor will commonly operate at different frame rates, it can be advantageous to define the frame rate of the optical code sequence to be lower than both the frame rate of the display and the frame rate of the image sensor (i.e., each optical code frame is longer than each display frame and each captured frame). This can prevent optical code frames from being improperly displayed or captured.

### Localizing Optical Codes Based on Identification Features

In some embodiments, the optical codes of the respective channels are visually distinguished from one another, for example, to disambiguate the codes and facilitate decoding. In some embodiments, the optical code generator generates additional features to aid with distinguishing and localizing optical codes in a frame. In some embodiments, the additional features can be static with respect to the optical code sequence, and act to demarcate or delineate locations of separate optical codes. In addition to disambiguating codes to speed up decoding and make decoding more accurate, providing optical cues to distinguish optical codes can advantageously allow the optical codes to be positioned closer together. This can reduce empty display space, which in turn enables the communication of more optical codes simultaneously, and/or the communication of larger optical codes which occupy more display space and thus are less prone to communication errors or contain more data.

FIG. 7 illustrates one frame of an optical sequence communicated by a sending device, where two optical codes 710 and 720 are communicated simultaneously, spatially separated. In FIG. 7, optical code 710 is black and white on white background 712, whereas code 720 is white and black on black background 722. In some implementations, optical code 710 can be surrounded by a white border 722 and optical code 720 can be surrounded by a black border 722; in other implementations, optical code 720 can be inverted, such that each white pixel is converted to black (including background/border 722), and each black pixel is converted to white. A cooperating receiving device (e.g. a code reader) can be configured to interpret these features to localize and separate the optical codes.

FIG. 8A illustrates one frame of an optical sequence communicated by a sending device, where two optical codes 810 and 820 are communicated simultaneously, spatially separated. In FIG. 8A, markers 830 are communicated/positioned around and/or between the optical codes 810 and 820. Markers 830 provide a clear, easily decoded indication of where each optical code is, and where the boundaries between optical codes are. When a receiving device processes an image including optical codes and markers 830, the processor can easily localize and identify where optical codes are positioned within an image, as well as boundaries between multiple optical codes.

Markers 830 are shown at the corners of each of the optical codes, but such markers could be positioned anywhere appropriate, such as centered along an edge of an optical code. Further, markers 830 are shown as being positioned at each corner of optical codes 810 and 830, but it is within the scope of the present disclosure to include fewer or more markers. For example FIG. 8B illustrates one frame of an optical sequence communicated by a sending device similar to frame 8A, except markers 830 are positioned only between optical code 810 and optical code 820.

Any appropriate markers can be used, such as the Secchi disk patterns of markers 830 in FIGS. 8A and 8B. FIG. 8C illustrates several other exemplary marker types, including circle 831, corner 832, triangle 833, and cross 834. Further, different markers can be used in combination, in any appropriate pattern, to delimit optical codes. FIG. 8D illustrates one example, where different markers are used to mark different optical codes and the boundaries therebetween. In particular, corners 832 are used to mark one side of optical code 810, Secchi patterns 830 are used to mark the boundary between optical codes 810 and 820, and crosses 834 are used to mark one side of optical code 820.

### Decoding Operations Based on Region of Interest

When communicating a sequence of codes, a receiving device receives the codes using an image sensor that defines images or frames of a video, such as image sensor 122 discussed with reference to FIG. 1. A decoder component processes the images. For example, at least one processor included in or communicatively coupled to the receiving device can process and decode the images to identify optical codes represented therein. To improve decoding speed, identifying an optical code in an image can involve localization—determining where the code is in the image. In some cases, localization can also include determining an orientation of the code in the image.

In an embodiment, in a first image captured at a receiving device, one or more optical codes may be detected and localized (e.g, using attributes like shape of size of the optical code, using localization features in the optical code, using unique/proprietary localization features, etc). If optical code detection is successful, a region of interest is stored (e.g. X and Y coordinates and Height and Width of a bounding box) defined by the size and location of the first optical code in the image data. Optionally, the size can be an expandable region responsive to the size of the detected optical code. This region of interest can be used to locate subsequent codes in subsequent frames. The technique may be useful in sequences of single or multiple codes per frame.

FIG. 9A illustrates an exemplary implementation of the above embodiment. In FIG. 9A, one frame of an optical sequence communicated by a sending device is illustrated. The example of FIG. 9A shows two optical codes 910 and 920 communicated simultaneously in one frame, but more or less optical codes could be included in a single frame as discussed earlier. In the example of FIG. 9A, an image sensor of a receiving device can capture an image 900. Within the image 900, a region of interest 940 can be identified and stored based on the shape and size of the optical codes, fiducial markers in the optical codes (corner markers 911 in optical code 910 and corner markers 912 in optical code 920), and/or markers 830 positioned near the optical codes. In a subsequently communicated frame, instead of analyzing an entire image captured by an image sensor, the receiving device can analyze only the region of interest 940 in the new frame.

The region of interest approach may improve image processing time (less time to detect and decode optical codes) and make detection more robust. However, in some cases, the optical codes communicated in a subsequent frame may not be completely within the identified region of interest. For example, the sending device or the receiving device (or the display and image sensor respectively thereof) could move. In such a situation, the receiving device may fail to identify and decode an optical code. This could be handled in a number of ways. As one example, after failing to identify an optical code in a frame, the receiving device could attempt the identify the optical code again, analyzing a larger area of the image (e.g., the region of interest can be expanded for an additional attempt). As another example, the receiving device could attempt the identify the optical code again, analyzing the entire captured image. These exemplary additional attempts could be performed immediately subsequent the failed attempt, or could be performed during a subsequent loop of the sequence being communicated.

In some implementations, the region of interest could be regularly updated. For example, at regular intervals (or even every frame), the receiving device could detect and localize the optical codes in the region of interest. Further, based on the position of the optical codes within the region of interest, the region of interest could be updated for the next frame. An example of this is illustrated in FIG. 9B. FIG. 9B illustrates optical codes 910 and 920 communicated in a frame, positioned at a bottom-right corner of region of interest 940. Optical codes 910 and 920 may have moved away from a center of region of interest 940 because of movement of the sending device or the receiving device, for example. If the movement continues, subsequent optical codes may be outside the region of interest, resulting in failed decoding. To pre-empt this issue, the receiving device can update the stored region of interest to new region of interest 942, centered on the position of optical codes 910 and 920. In this way, as long as the optical codes don't move out of the region of interest before a frame where the region of interest is updated, then the region of interest can move with the optical codes. Consequently, moderate misalignment of the region of interest can be addressed, improving decoding accuracy.

### Feedback on Frames and Selective Representing

In some embodiments, user interfaces (UIs) such as graphical user interfaces (GUIs) for sending and receiving devices are configured to provide feedback on frames (or optical codes) that were received (decoded) or not received (not decoded) by the receiving device and to facilitate communication of the frames by the sending device.

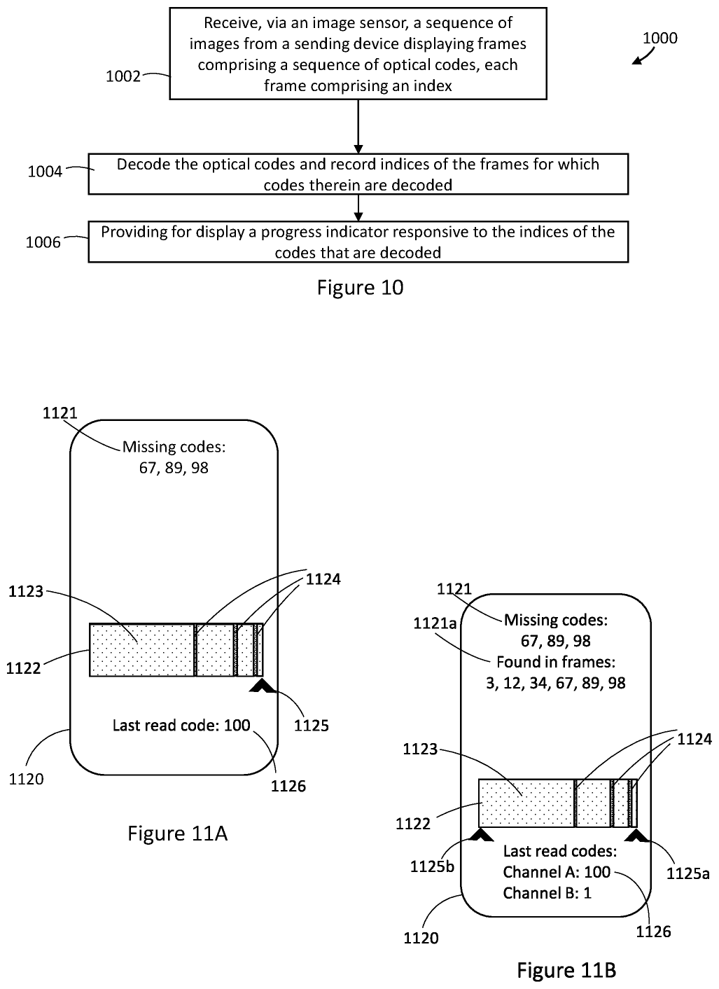

FIG. 10 is a flowchart diagram which illustrates an exemplary method 1000 for providing feedback on frame status. Method 1000 includes at least act 1002, 1004, and 1006, but could include additional acts as appropriate for a given application. The acts of method 1000 can be performed by a processor or image sensor included in a receiving device, or could be performed by a processor or image sensor communicatively coupled to, but not physically included in, the receiving device.

In act 1002, a receiving device (such as receiving device 120 of FIG. 1) receives via an image sensor a sequence of images from a sending device (such as sending device 110 in FIG. 1) which displays frames comprising a sequence of optical codes. Each frame includes an index.

In act 1004, the receiving device decodes the optical codes, and records indices of frames for which the optical codes therein were successfully decoded. For example, a processor of the receiving device attempts to decode optical codes in each frame received, and stores a list of indices of properly decoded frames in a non-transitory processor-readable medium of the receiving device. Alternatively, the processor could store a list of frame indices for frames including optical codes which were not properly decoded (which would implicitly indicate frames for which optical codes were properly decoded).

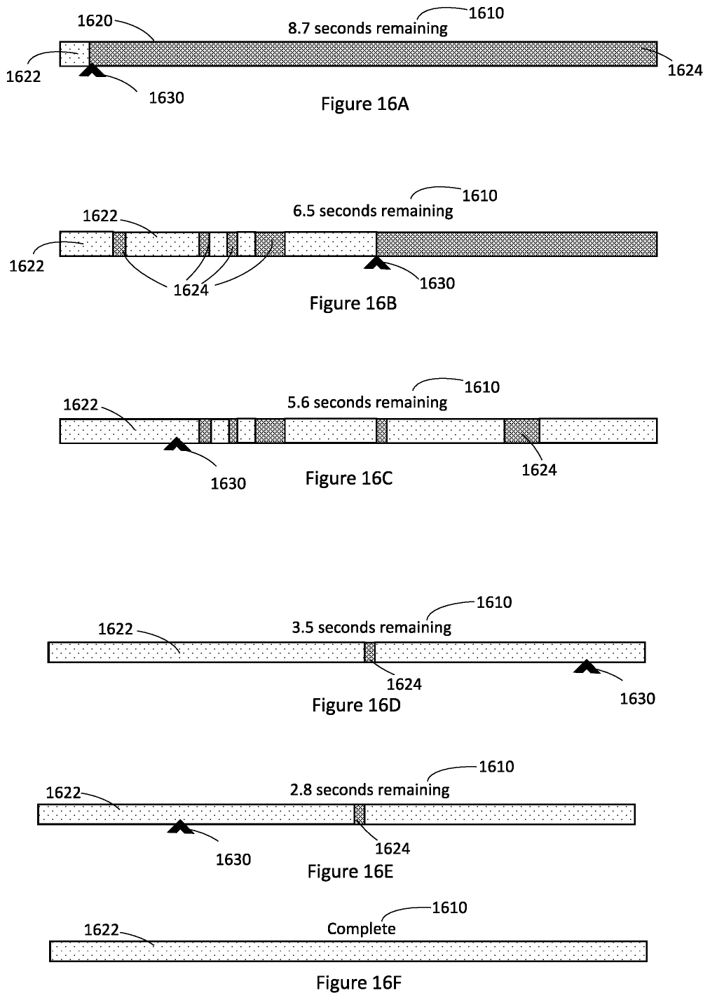

In act 1006, the receiving device provides for display a progress indicator responsive to indices of frames for which the optical codes therein were successfully decoded. Examples of this are discussed below with reference to FIGS. 11A, 11B, and 16A-16F.

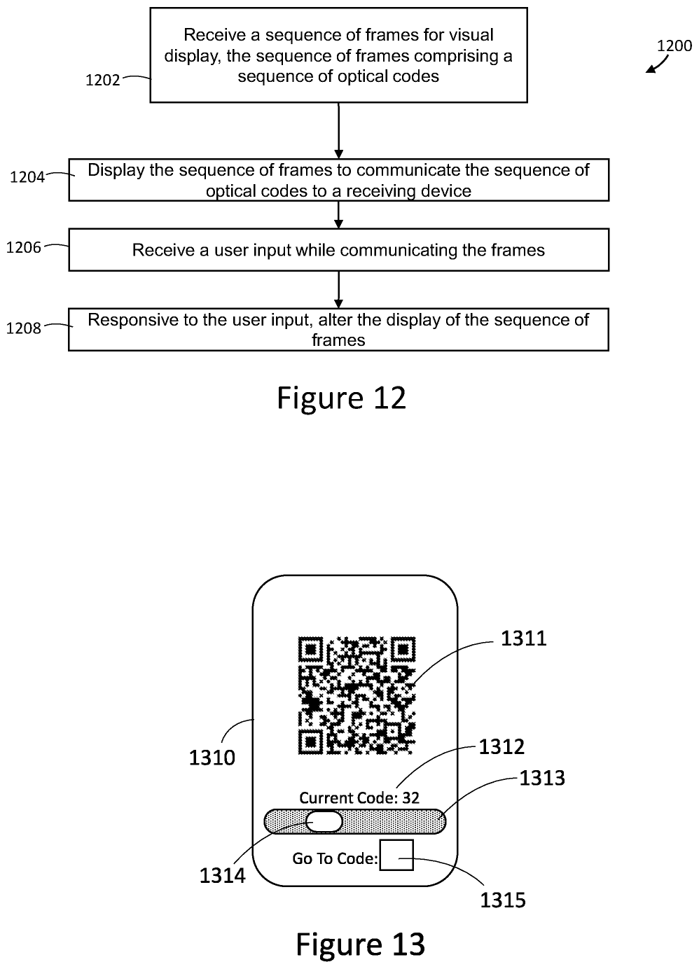

FIG. 11A illustrates an exemplary user interface indicating decoded or not decoded optical codes. This can be useful in tandem with user mechanisms for controlling communication of the missing codes, as will be discussed later with reference to FIGS. 12 and 13.

FIG. 11A illustrates a display of a receiving device 1120, which can be similar to receiving device 120 discussed with reference to FIG. 1 above. Although the dimensions of the display of receiving device 1120 approximately correspond to a smartphone display, any appropriate device could be used. In the example of FIG. 11A, a sequence of optical codes was communicated from a sending device (not shown) to receiving device 1120. The sequence of optical codes is discussed as being 100 codes, but any appropriate number of codes is possible. In the example of FIG. 11A, the sequence of codes are communicated in a sequence of frames, with one code comprised in each frame, such that an optical code index for each code corresponds to a frame index for each frame. However, it is possible to include multiple optical codes in one frame, as discussed above with reference to FIGS. 2A-2B, 3A-3B, 4A-4C, 5A-5B, and 6A-6B, and as further discussed below with reference to FIG. 11B.

In the example of FIG. 11A, the receiving device 1120 has properly received 97 of the 100 optical codes, but missed or improperly received three codes. In this example, and with reference to act 1004 in FIG. 10, the indices of the three missing codes were recorded as 67, 89, and 98 (or were determined by recording indices of every properly decoded code, and identifying which codes were missing). The UI of the receiving device 1120 displays which codes are missing (i.e. the indices of those codes) in a text-based indicator 1121. The UI of the receiving device also display a progress bar 1122, which visually indicates codes 1123 which were properly decoded and codes 1124 which were not properly decoded. Note that it is not necessary for both text-based indicator 1121 and progress bar 1122 to be presented; it is within the scope herein to present only one of these indicators.

The UI of the sending device 1120 can also optionally display other indicators 1125 and/or 1126, which indicate which code was most recently decoded. Indicator 1125 is a visual marker on the progress bar 1122, whereas indicator 1126 is a text-based indicator stating the last read code. In an embodiment receiving device 1120 presents neither of, one of, or both of indicator 1125 and indicator 1126. In an embodiment, a different indicator is presented which has similar functionality as indicators 1125 and 1126. Advantageously, by indicating the last read/decoded code, a status of the transfer operation as a whole can be determined. In this example of FIG. 11A, it can be seen that the sequence of codes has been communicated once, since the last decoded code is code 100, the final code in the sequence. In other examples, the full sequence of codes may have not yet been communicated, and the indicator 1125 or the indicator 1126 can indicate such.

FIG. 11B illustrates another exemplary user interface indicating decoded or not decoded optical codes. FIG. 11B is similar to FIG. 11A, and discussion of FIG. 11A is applicable to FIG. 11B unless context clearly dictates otherwise.

A difference between FIG. 11A and FIG. 11B is that FIG. 11B is an exemplary user interface presented when the receiving device received or is receiving a sequence of frames, with each frame including multiple optical codes (that is, there are multiple optical code channels, as discussed with reference to FIGS. 2A-2B, 3A-3B, 4A-4C, 5A-5B, and 6A-6B). In such a scenario, optical code indices may not match frame indices. Further, the multi-channel communication structure, and optical code indices in general, may not be known to the user. However, the concept of “frames” is generally known. Therefore, it can be desirable to present to the user a progress indicator 1121a which indicates frame indices in which non-decoded optical codes can be found. In this way, as will be discussed later, the user can control a sending device to transfer the specific frames needed to decode the remaining optical codes.

In the example of FIG. 11B, the missing optical codes are indicated at 1121, and the frame indices where those optical codes can be found are indicated by 1121a. However, presenting so many indices may be confusing to the user, and in some implementations only the frame indices which comprise the missing optical codes can be presented. Further, in the example of FIG. 11B, 6 frame indices are displayed for 3 missing optical codes. This is because each optical code can appear in two frames. However, this also could be confusing to the user, and instead the displayed frame indices could be limited such that only one frame index is presented for each missing optical code. Further, if multiple missing optical codes are included in a single frame, the displayed list of frames could be reduced further by displaying the fewest number of frames which include all of the missing optical codes.

Progress bar 1122, indicator 1125, and indicator 1126 can be adapted to display either optical code indices or frame indices, or multiple indicators could be displayed to indicate both frame indices and optical code indices, if desired. For example, FIG. 11B shows an optional implementation with two indicators 1125a and 1125b. Indicator 1125a can indicate a last read code (or code currently being read) in the optical code sequence, with regards to a first channel (Channel A). Indicator 1125b can indicate a last read code (or code currently being read) in the optical code sequence, with regards to a second channel (Channel B). For example channels A and B could present the sequence of optical codes in opposite orders, as discussed above. In the case of FIG. 11B, Channel A can communicate the optical codes in forward order, such that indicator 1125a will move left-to-right over progress bar 1122, whereas Channel B can communicate the optical codes in reverse order, such indicator 1125b can move right-to-left in progress bar 1122. Other communication orders are possible, as discussed above. Further, indicator 1126 can optionally indicate the last read code for multiple channels, as shown in FIG. 11B.

### User Control of Optical Code Communication

In certain scenarios, it is desirable for a user to be able to manually control communication of optical codes by a sending device. For example, when certain codes are not properly received or decoded by a receiving device, it may be desirable for a user to manually cause the sending device to communicate only the missing codes. Communication status information provided by a receiving device, such as described above with reference to FIGS. 10 and 11A-11B, can be useful to inform the user what optical codes still need to be communicated.

FIG. 12 is a flowchart diagram which illustrates a method 1200. Method 1200 includes at least acts 1202, 1204, 1206, and 1208, although additional acts could be added as appropriate. Acts 1202, 1206, and 1208 can be performed by a processor of a sending device (such as sending device 110 in FIG. 1), but could also be performed by a processor which is communicatively coupled to, but not physically included in, the sending device.

In act 1202, a sending device receives a sequence of frames for visual display, the sequence of frames comprising a sequence of optical codes. In some implementations, a sequence generator on the sending device could generate the sequence of optical codes and the sequence of frames. In other implementations, the sending device could receive the sequence of frames or codes from another device.

In act 1204, the sending device displays the sequence of frames to communicate the sequence of optical codes to a receiving device. Act 1204 can be performed by a display element of the sending device.

In act 1206, the sending device receives a user input while communicating the frames. In this context, “while communicating the frames” refers to a time before the sequence of optical codes is fully communicated. If display of the frames is paused, but the sequence of optical codes is not yet fully communicated, this can still be considered as “while communicating the frames”. User input can be received by any appropriate interface of the sending device, such as a touchscreen or microphone. Further, user input can also be received by the sending device via peripheral interfaces which are not physically part of the sending device, such as a mouse, keyboard, remote control, or other appropriate interfaces. Such peripheral devices can communicate with the sending device via physical coupling (e.g. a wire) or wireless coupling. User input can indicate any of a plurality of commands from the user, and can be processed by the sending device, or can be processed externally to the sending device, with the resulting commands being provided to the sending device.

In act 1208, responsive to the user input, the sending device alters the display of the sequence of frames. In one example, the user can provide a pause command to the sending device, and in response the sending device will stop progressing through the sequence of frames (e.g. a video or animation file presenting the sequence can be paused). In another example, the user can provide a speed-up or slow-down command to the sending device, and in response the sending device will progress through the sequence of frames faster or slower (e.g. a video or animation file presenting the sequence can be sped-up or slowed-down). In yet another example, a user can provide a command to manually select a frame to display, as discussed in detail with reference to FIG. 13 below.

FIG. 13 illustrates an exemplary user interface for controlling communication of optical codes. This can be useful in tandem with mechanisms for reporting frame statuses and missing codes, as discussed above with reference to FIGS. 10 and 11A-11B.

FIG. 13 illustrates a sending device 1310, which can be similar to sending device 110 in FIG. 1. The sending device 1310 can present a UI to facilitate a user to retrieve the exact optical codes which were not properly decoded. The UI in FIG. 13 could be presented for example in response to a user pausing communication of the optical codes (perhaps because the communication was repeatedly looping and failing). Alternatively, the UI in FIG. 13 could be presented automatically after an optical code sequence has failed to be completely communicated after a certain number of loops (which could include one loop, or a plurality of loops).

In the UI of FIG. 13, the sequence of optical codes (e.g. the video or animation in which the optical codes are encoded) could be navigable by a user of the sending device 1310, via its UI, with the index of the code or frame numerically represented by the UI. As mentioned above, in the example of FIG. 13, playback of the optical frame sequence is “paused”; that is, a single frame of optical code(s) is presented (illustrated as optical code 1311) along with an index 1312 corresponding to the optical code. In cases where multiple channels of optical codes are communicated in each frame, the index 1312 could indicate a frame index rather than a code index; a list of code indices for codes in the frame could be displayed as well, if desired. The user is presented with the ability to select an optical code/frame to display, such that the optical code(s) 1311 being displayed changes when the user selects a different code/frame index. For example, sending device 1310 can display a scroll bar 1313 with scroll handle 1314. The user can move the scroll handle to “scroll” through the optical codes/frames, until code/frame index 1312 matches the index of a code/frame which a receiving device is missing. Such movement of the scroll handle could be achieved using a human interface device such as a mouse or arrow keys, or by touching and dragging the scroll handle via a touchscreen, as non-limiting examples. FIG. 13 also illustrates a selection box 1315, where a user can manually input a code/frame index (such as with a physical or virtual keyboard or number-pad, or with a drop-down menu, as non-limiting examples), and once the index is input, the displayed optical code(s) 1311 will change to the optical code(s) corresponding to the input index. Other appropriate means of selecting the optical code frame to display fall within the scope of the present disclosure. For example, each of the optical codes/frames could be presented to a user as static images in a list or other structure, and the user can select the desired optical code/frame from the list.

Once the desired optical code frame is selected and displayed, the user presents the display of sending device 1310 to the image sensor of the receiving device. Scrolling controls and frame number etc. are presented so as not to interfere with the optical code(s) 1311. The receiving device can then receive and decode the missing frame. These operations can be performed for each missing frame.

In some implementations, display of select optical codes or frames could be performed autonomously. For example, the sending device could include an accelerometer; when movement exceeding a threshold is detected by the accelerometer, a processor of the sending device could determine select codes/frames being communicated during the movement which were likely not received correctly. The sending device could then display these select frames, for reception by the receiving device.

### Adjust Play Speed Dynamically/Programmatically

One reason that an optical code frame or frames can be missed (that is, that less than all of the optical codes are properly received and decoded) is that the processing resources of the receiving device are insufficient to complete receiving and decoding operations in the time of a single presentation of the optical code sequence. Another reason could be limitations in physical detection capabilities of a receiving device, such as resolution, frame rate, and exposure time of an image sensor.

In some embodiments, the sending device can be configured to present the sequence of optical codes at different speeds. For example, in a first loop, the sending device can communicate the sequence of optical frames at a first speed (relatively high frames per second, or “FPS”), and for each subsequent loop, the sequence of optical frames can be presented at a successively lower speed (that is, the number of optical code frames presented per second is reduced). In an exemplary implementation, the sequence of optical frames can be communicated in a first loop at 30 FPS, in a second loop at 15 FPS, in a third loop at 7.5 FPS, in a fourth loop at 3.25 fps, and so forth. In this example, the playback speed or FPS is reduced by half in each subsequent loop. However, this set of playback speeds and progression is exemplary, and any appropriate starting speeds and progressions can be chosen as appropriate for a given application. An optimal progression may be determined to minimize an expected or average read time for optical code sequences in general. For example, a progression could be determined in which most optical code sequences can be properly read within the first two or three loops, but in subsequent loops the playback speed may be reduced drastically in order to provide flexibility to read particularly difficult to decode sequences. The determined progression can be based on or account for hardware components of the system, including sending device display capabilities and receiving device processing capabilities, as non-limiting examples.

Further, playback speed can be reduced in each subsequent loop indefinitely, or a threshold minimum can be set, where the playback speed will not decrease beyond the minimum, to prevent the optical code communication from taking excessively long. Additionally or alternatively, a maximum number of loop times can be set, such that the system does not continue looping indefinitely. Systems with such speed or loop number thresholds can be implemented together with manual intervention mechanisms, such as those discussed with reference to FIGS. 12 and 13. For example, if a threshold minimum playback speed is reached, or if a maximum number of loops is reached, the receiving device can present a message which informs the user of the missing frames, and the user can navigate the optical code frames on the sending device to explicitly control communication of the missing frames.

### Optical Code Contains Information to Verify Usage

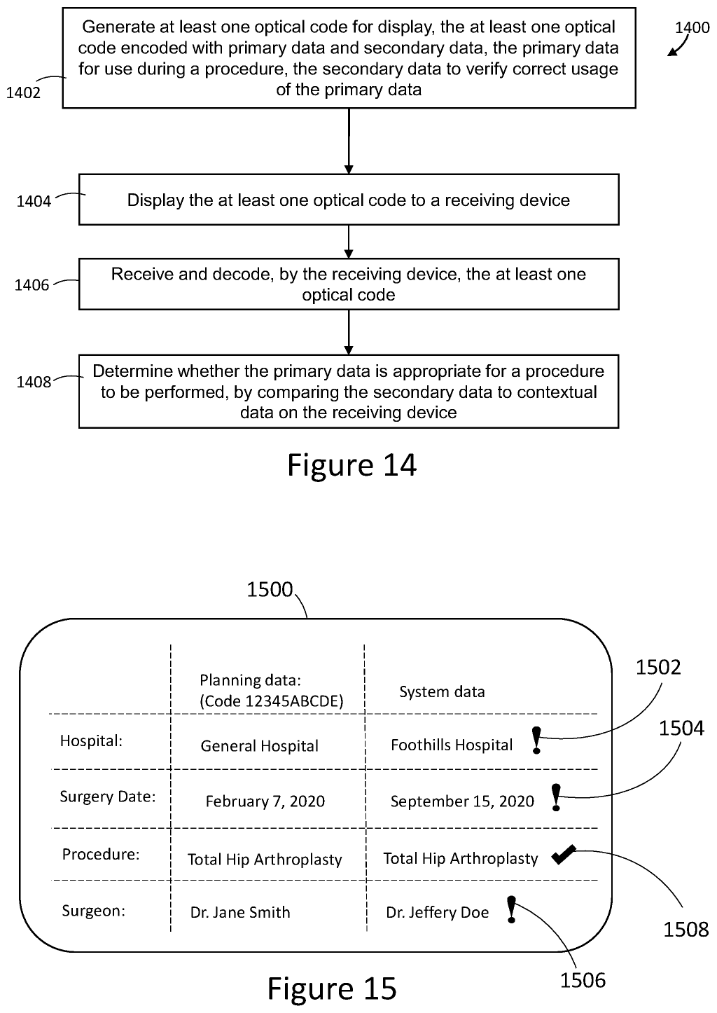

In some implementations, optical codes may contain information regarding their usage. In this regard, FIG. 14 is a flowchart diagram which illustrates a method 1400. Method 1400 can include at least acts 1402, 1404, 1406, and 1408, but additional acts can be added as appropriate.

In act 1402, at least one optical code (which could include a sequence of optical codes) is generated for display by a sequence generator. The sequence generator could be implemented on a processor of a sending device, or could be implemented on a processor in communication with, but not necessarily physically coupled to, the sending device. The at least one optical code can be encoded with primary data and secondary data, the primary data for use during a procedure, and the secondary data to verify correct usage of the primary data. The secondary data may be context dependent, defined in relation to how primary data in the at least one optical code is to be used. In the example of information for surgical procedures, primary data refers to data which directly affects how the surgical procedure is carried out (for example, pre-operative alignment goals for the surgery, attributes or images of an anatomy to be handled during the surgery, or other such appropriate data). Secondary data, on the other hand, while related to the surgery, is not actually used during the surgery (for example, a hospital identification, a surgeon name, a patient name, a valid date or date range of the surgery, or other such information).

In act 1404, the at least one optical code can be used to transmit surgical procedure information from the sending device (e.g. a smartphone) to a receiving device (e.g. an intraoperative computing device configured to assist with the surgical procedure), by the sending device displaying the at least one optical code to the receiving device. The sending device and receiving device can be similar to sending device 110 and receiving device 120 discussed above with reference to FIG. 1.

In act 1406, the receiving device can receive and decode the primary data and the secondary data from the at least one optical code.

In act 1408, the receiving device determine whether the primary data is appropriate for a procedure to be performed, by comparing the secondary data to contextual data on the receiving device. This can determine whether the secondary data is valid, and thus is indicative of whether the primary data should be used. That is, the receiving device can use the secondary data to validate use of primary data to prevent incorrect usage.

An exemplary scenario is discussed with reference to FIG. 15, which shows a display 1500 of an intraoperative computing device (receiving device). In the scenario of FIG. 15, the sending device is operated by a representative of a surgical localization system of which the intraoperative computing device (receiving device) is a component. Prior to a surgical procedure, pre-operative planning data (as an example) is encoded into frames of optical codes using a sequence generator to define a sequence of optical codes for presenting to the receiving device. In some implementations, the sequence generator can be implemented on a computing device different from the sending device. For example, the sequence generator can be implemented on a planning computing device which outputs the planning data as a sequence of optical codes. In other implementations, the sequence generator can be implemented on an intermediate device which receives planning data from the computing device and encodes the planning data into a sequence of optical codes. In these implementations, the sequence from the sequence generator can be communicated to the sending device, for example as an email with an attachment. The email can be associated with a case reference. In other implementations, the sequence generator can be implemented on the sending device, which receives planning data from the planning computing device and encodes the planning data into a sequence of optical codes, for sending.

In the exemplary scenario, to configure the intraoperative computing device for a surgical procedure, the representative looks for an optical code planning data email by typing in a case number that they have written down for the case (e.g., a 10 digit code). The representative makes an error, for example by mistyping the case number or by miswriting the case number, and accesses another optical code sequence which pertains to another surgery (e.g. a different surgical procedure, a different surgeon, a different hospital, a different patient, a different or expired date, or any other different context information), and does not immediately identify the error. The representative proceeds to cause the optical code sequence to be communicated from the sending device to the intraoperative computing device as the receiving device. The receiving device, via a verification component, decodes the secondary data, for example, containing expected dates of surgery, hospital etc., and compares this decoded secondary data (secondary information) to contextual data (context information) on the receiving device. The receiving device identifies a mismatch between the secondary data and the contextual data and alerts the representative that an incorrect case has been loaded.

In the example of FIG. 15, the secondary data includes the hospital name, the surgery date, the procedure being performed, and the surgeon name. The verification component of the receiving device compares this secondary data to contextual data stored on the receiving device. In the example of FIG. 15, the verification component determines that the hospital to which the receiving device is registered does not match the hospital indicated in the secondary data, and outputs an alert 1502. Further, the verification component determines that the current date as determined by a clock of the receiving device does not match the surgery date indicated in the secondary data, and outputs an alert 1504. Although in FIG. 15 the surgery date is a single date, in an embodiment, the surgery date includes a range of dates. Further still, the verification component determines that the name of the surgeon using the receiving device (e.g., by a user account login or similar) does not match the surgeon name indicated in the secondary data, and outputs an alert 1506.

FIG. 15 also illustrates that the verification component determines that the surgery being performed (for example by selecting a surgery workflow on the receiving device) does match the surgery indicated in the secondary data, and outputs a confirmation 1508. Output of such a confirmation is optional, and in some implementations no confirmation can be output; instead, only mismatches between the secondary data and the contextual data may be highlighted by an alert. Further, display 1500 may be limited such that only mismatches between the secondary data and the contextual data are displayed at all, which can provide a more streamlined interface if there are many pieces of secondary data.

Further, although a single piece of secondary data can be compared to contextual data of the receiving device to verify that a correct sequence of optical codes was received, greater accuracy can be achieved by comparing several pieces of secondary data to contextual data on of the receiving device. In the example of FIG. 15, if only the surgical procedure in the secondary data were compared to contextual data of the receiving device, the verification component would have falsely determined that the correct sequence of optical codes was communicated. By comparing several pieces of secondary data with the contextual data as in FIG. 15, the risk of false verification is reduced.

Based on the alerts presented, the representative can identify that the incorrect optical code sequence was communicated, and may proceed to redo the communication steps from the sending device to the receiving device, to communicate the correct sequence. In some cases, however, the representative may apply his or her own judgement and choose to continue with the surgical procedure based on the already communicated optical code sequence. In particular, the representative may be able to determine that any mismatches are not material concerns, and that the communicated optical code sequence is in fact correct. For example, the receiving device may be on loan from a different hospital, such that hospital information stored in the receiving device is not accurate. As another example, the surgery may have been rescheduled, such that the surgery date in the secondary data is not accurate.

In other embodiments, the receiving device (intraoperative computing device) can be configured to require a match or verification of the secondary data with the contextual data to enable display or other presentation of the decoded primary data. That is, instead of just alerting the representative when the received secondary data doesn't match contextual data on the receiving device, the receiving device may refuse to proceed with the procedure until an optical code sequence is communicated in which the secondary data in the optical code sequence matches contextual data stored on the receiving device.

Advantageously, the concepts discussed with reference to FIG. 15 enable verification of received data even when the receiving device knows nothing of the received data prior to receipt. The implementations discussed with reference to FIG. 15 are discussed in the context of surgical procedures, but the principles can be applied to any appropriate use cases.

Further, when generating a reference code for the sequence of optical codes, the sequence generator can structure the reference code so that case with similar reference codes are particularly distant in time, to increase the probability that the verification component will detect a mismatch between the surgery date or date range in the secondary data and the date in the contextual data at the receiving device. For example, the sequence generator could generate a reference code of 1AB6, and verify that all codes of the format xAB6, 1xB6, 1Ax6, and 1Abx (where “x” can be any valid character in the code) occur more than 2 months from the expected date of surgery. That way if one character is mistyped, this verification component is likely to identify this.

### Receiving Device Status Presentation

As discussed above, FIG. 10 illustrates a method 1000 for providing feedback on status of optical code transmission. In some implementations of such a method, a receiving device can calculate and display an estimate of how long until a full sequence of optical codes is read. For example, providing a progress indicator as in act 1006 can entail providing for display a progress indicator of transmission time for the optical codes. For example, the receiving device can make an assumption about an expected number of failures (i.e., the receiving device can project the number of errors), and determine an expected number of loops of the sequence of optical codes before each optical code is successfully decoded. An estimated remaining time can be calculated by the formula:

remaining time=(time left in current loop)+n*(time for full loop)

where n represents the expected number of full loops remaining before completion. In some implementations, the length of a single loop can be known to the receiving device, such as by the sending device and the receiving device communicating in a standardized format where sequences of optical codes have a standard length. In cases where playback speed changes for successive loops, as discussed earlier, the progression of playback speeds and/or loop lengths can be known to the receiving device. In other implementations, the receiving device can determine the length of a single loop by timing the first loop, and determining the remaining time after the first loop has played. In cases where playback speed changes for successive loops, as discussed earlier, the progression of playback speeds and/or loop lengths can be estimated by the receiving device, and the remaining time updated as more loops are played and the estimate becomes more accurate. In other implementations, the receiving device can determine the length of a single loop by determining or measuring the frequency of image transitions (i.e., how often the sending device changes frames in a frame sequence), and calculating the time of one loop (and the remaining transition time) from the frequency of image transitions. In cases where playback speed changes for successive loops, as discussed earlier, the progression of playback speeds and/or loop lengths can be estimated by the receiving device determining a new frequency of image transitions for each loop.

The receiving device can derive the time left in the current loop by subtracting a time since the current loop began from the length of a full loop.

In some implementations, the receiving device can determine n based on historical data, for example by cataloging previous communications and determining an average number of loops required for completion of these communications. In other implementations, n can be provided to the receiving device during configuration.

Exemplary remaining time estimates are illustrated in FIGS. 16A-16F, discussed below.

In addition or alternative to an estimate of remaining time, the receiving device can visually indicate a status of communication, including which frames are properly decoded and which frames are not properly decoded, so a user can know exactly that the receiving device is expecting. FIG. 16A-16F illustrate a representative interface in accordance with an exemplary implementation.

FIGS. 16A-16F illustrate a time estimate 1610, which indicates estimated remaining time of a transfer as discussed above. FIGS. 16A-16F also illustrate a status bar 1620, which indicates read codes/frames 1622 and unread codes/frames 1624. FIGS. 16A-16F also illustrates a marker 1630 which indicates the current code/frame being decoded by the receiving device. Status bar 1620 can be indicative of decoded/undecoded optical codes, or indicative of frames containing decoded/undecoded optical codes. The example of FIGS. 16A-16F shows status bar 1620 as it would appear for frame sequences containing a single optical code per frame. However, the discussion of FIGS. 16A-16F also applies to implementations where multiple channels of optical codes are displayed in each frame, as is discussed later.

In FIG. 16A, the receiving device has recently started receiving a sequence of optical codes, and is currently in a first playback loop of the sequence. Marker 1630 indicates that the receiving device is decoding a frame near the beginning of the sequence. Status bar 1620 shows that the receiving device has successfully decoded previous frames 1622, and has not yet received frames 1624.

In FIG. 16B, the receiving device is partway through the first loop, as indicated by marker 1630. The receiving device successfully decoded a number of frames, indicated by 1622, and the receiving device failed to successfully decode a number of frames, indicated as non-decoded frames 1624.

In FIG. 16C, the receiving device has commenced a second loop of the sequence, and it is currently receiving a frame indicated by marker 1630. Compared to FIG. 16B, a leftmost non-decoded frame 1624 was successfully decoded in the second loop, and so the status bar 1620 in FIG. 16C now shows this frame as a successfully decoded frame 1622.

In FIG. 16D, the receiving device has continued the second loop of the sequence, and it is currently receiving a frame near the end of the sequence indicated by marker 1630. Compared to FIG. 16B, most of the non-decoded frames 1624 were successfully decoded in the second loop, and so the status bar 1620 in FIG. 16C now shows these frames as successfully decoded frames 1622.

In FIG. 16E, the receiving device has commenced a third loop of the sequence, and it is currently receiving a frame indicated by marker 1630. In this third loop, the receiving device will attempt to properly decode the last non-decoded frame 1624.

In FIG. 16F, the receiving device has finished the third loop, having successfully decoded the last non-decoded frame 1624 illustrated in FIG. 16E. All of the frames of the sequence are shown in FIG. 16F as successfully decoded frames 1622.

In each of the successive FIGS. 16A-16E, the estimated time remaining 1610 is updated to provide a live estimate of remaining time to decode the optical codes to a user (a countdown timer), for example using the estimation techniques discussed above. In FIG. 16F, the estimated remaining time 1610 is changed to a “Complete” status indicator. In other implementations, once complete the estimated remaining time could be displayed as 0 seconds. Alternatively, the entire interface, including estimated time 1610, status bar 1620, and marker 1630 can be replaced with a “Complete” status indicator.

As mentioned above, the techniques of FIGS. 16A-16F can be applied to implementations where multiple optical code channels are displayed in each frame. In such examples, optical codes having different optical code indices can be displayed in a single frame, and therefore the frame index doesn't match the optical code index. In such cases, status bar 1620 can indicate optical code indices for optical codes which have been decoded or not, or status bar 1620 can indicate frame indices for frames containing optical codes which have been decoded or not. Alternatively, separate status bars can be displayed which indicate optical code indices for optical codes which have been decoded or not, and frame indices for frames containing optical codes which have been decoded or not. In either case, a status bar may not necessarily be updated in a strictly directional manner; rather, indices in the status bar may be updated in a piecewise manner, where different areas of the status bar are updated at different times.

### Sequence Generator Operations to Encode Data

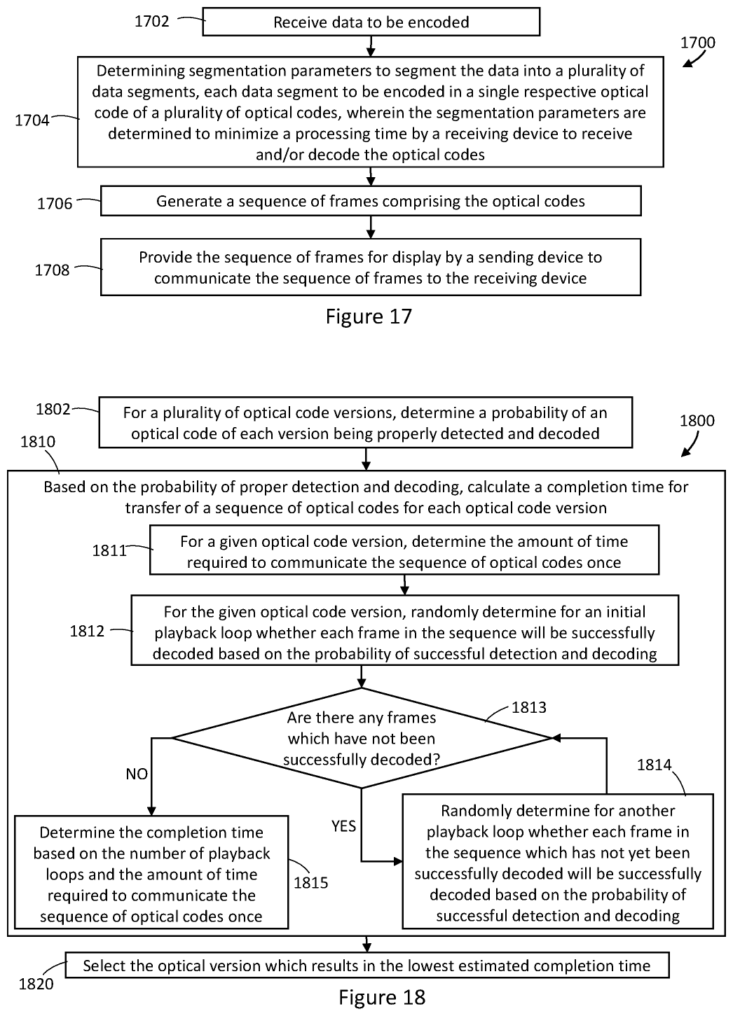

FIG. 17 is a flowchart diagram which illustrates an exemplary method 1700 for encoding data into optical codes and providing frames for display. Method 1700 includes at least acts 1702, 1704, 1706, and 1708, but additional acts could be added as appropriate for a given application. Further, the order of acts in method 1700 could be altered as appropriate.

In act 1702, an encoding device receives data to be encoded. Such an encoding device could be similar to sending device 110 in FIG. 1, or could be another device which encodes data and provides the data to sending device 110. The encoding device can include at least one processor for performing the encoding.

In act 1704, segmentation parameters are determined to segment the data into a plurality of data segments. Each data segment is to be encoded in a single respective optical code of a plurality of optical codes, and the segmentation parameters are determined to minimize a processing time by a receiving device to receive and/or decode the optical codes. Exemplary techniques for determining segmentation parameters are discussed below with reference to FIG. 18.

In act 1706, a sequence of frames comprising the optical codes is generated. This can be performed by a sequence generator, which can be included in the sending device, or can be communicatively coupled to but not physically included in the sending device.

In act 1708, the sequence of frames is provided for display by a sending device to communicate the sequence of frames to the receiving device. This can include the sequence generator physically separate from the sending device transmitting the sequence of frames to the sending device, or the sequence generator included in the sending device providing the sequence of frames to a display component of the sending device.

Act 1704 focuses on determining segmentation parameters to segment the data. In particular, when transmitting data over a sequence of optical codes, the data is split up into sections which fit into individual codes. A single code can have a limited amount of information. For example, discussion of data capacity and error correction codes for QR Codes is available at URL: www.qrcode.com/en/about/version.html incorporated herein by reference. QR codes are available in a number of “symbol versions” (also called “symbols” or “versions”), where each QR Code symbol version has a maximum data capacity that varies with the amount of data, character type and error correction level. A QR Code comprises “modules” to encode the data, which refers to each individual unit in the QR code that can be black or white to encode a value. As the amount of data encoded in a single QR code increases, more modules are required in the QR Code, resulting in larger codes (symbols) in height and width. Such a “larger” QR code can require a greater physical area, and/or be denser (higher resolution) than a “smaller” QR code.

For example, a Version 1 QR Code is a grid of 21 by 21 modules, while a Version 40 QR Code is a grid of 177 by 177 modules. A Version 1 QR Code with low error correction code (ECC) stores 152 mixed data bits. A Version 5 QR code with medium ECC stores 688 mixed data bits and a Version 12 QR code with high ECC stores 1264 bits.

Table 1 below shows ECC (error correction code) levels for QR Codes:

TABLE 1
QR Code ECC Levels

| ECC Level | Word Recovery |
|---|---|
| L | 7% |
| M | 15% |
| Q | 25% |
| H | 30% |

ECC features of QR codes allow for restoration of data which is communicated erroneously, for example due to dirt, damage, or other problems in presentation of the code. Successive levels of ECC L, M, Q, and H can be chosen for a given QR code, with higher levels enabling greater data recovery, at the expense of being able to fit less data within the QR code. ECC features can include encoding of redundancy data. See the QR Code standard for more information.

The larger the QR Code, the more difficult it may be to read and decode by the receiving device. In some scenarios, a long sequence of small, low version QR codes may be faster to read and decode than a shorter sequence of fewer, higher version, QR Codes. This can be because the higher version QR codes may be more prone to reading and decoding errors, such that multiple loops may be needed to read every QR Code. Alternatively, each frame of the sequence may need to be displayed for a longer time to prevent reading and decoding errors.

That being said, in some scenarios a long sequence of small, low version QR codes may be slower to read and decode than a shorter sequence of fewer, higher version, QR Codes. This can be because if a sequence of fewer, higher version, QR Codes can be read without many errors, a long sequence of QR codes just extends the amount of reading time unnecessarily. Further, when encoding data, the data may be split into segments responsive to the size of the capacity of the QR Code. Padding can be used to fill out a segment as necessary so that each QR Code is of a same size. Further still, in addition to any format prescribed by the QR Code standard, a segment of data to be encoded may have a format comprising a sequence (index) number for the frame (or code), for example in a header or similar, and a body or payload portion encoding a portion of the whole data to be transmitted. As a result, a long sequence of small, low version QR codes may contain more overall padding data and more formatting/header data than a shorter sequence of fewer, higher version, QR Codes.

In view of the above, it is desirable to select an appropriate optical code version for a sequence of optical codes, such that overall time for communication is reduced, balancing speed of reading and decoding with probability for error. Although the above examples are discussed in the context of QR codes, similar concepts can apply to other forms of optical codes as well, such as linear barcodes.

In accordance with some embodiments, the sequence generator may provide optical code version selection options—e.g. a minimum and a maximum version that is useful to encode all of the data, and providing a choice (or making a determination) of the version(s) which best spread all the data out. By way of example, if there were 81,285 bits of data to encode, such data fits on 11 version 22 QR Codes (ECC level L), but also on 11 version 21 QR Codes (ECC level L). Version 21 would have a better chance of being read by the receiving device by virtue of being a smaller, less dense code. In this case, Version 21 would be preferable, because the data, once encoded in a sequence, would include the same number of QR Codes as if version 22 were used, but with a better per code chance of being successfully read and decoded.

In some embodiments, the sequence generator component can use predictive calculations or simulations, such as Monte Carlo simulations, to determine an optimal code version to minimize read time. In other embodiments, an optimal code version to minimize read time can be similarly determined by another computing device, and information indicated the optimal code version can be provided to the sequence generator component.

FIG. 18 is a flowchart diagram which illustrates an exemplary method 1800 for determining an optimal optical code version. Method 1800 includes at least acts 1802, 1810, and 1820. In the illustrated example, act 1810 includes acts 1811, 1812, 1813, 1814, and 1815, discussed below.

In Act 1802, for a plurality of optical code versions, a probability of an optical code of each version being properly detected and decoded by a receiving device can be determined. This could include, for example, using empirical testing to determine the probability of an optical code being properly detected/decoded for different versions and ECC levels. Such a determination can be specific to different combinations of sending devices and receiving devices. For example, a hardware setup could be assembled, with a sending device and receiving device prepared as they would be intended to be used for communication of a sequence of optical codes (for example, the sending device 110 and the receiving device 120 discussed with reference to FIG. 1 could be prepared). By testing with a hardware setup (or a simulated hardware setup), suitability of optical codes can be evaluated at least partially based on performance specifications of the sending device, and/or specifications of the camera and the receiving device. As a result, determined segmentation parameters can be based on performance specifications of the sending device, and/or specifications of the camera and the receiving device.

In such a setup, the sending device could communicate an optical code of a first version to the receiving device for a specified duration. This code be repeated a number of times (preferably a large number of times), and results could be tabulated which indicate how many communications failed, and how many succeeded, which indicates the probability that a given frame of the first optical code version will be properly detected and decoded. This could be repeated for a plurality of different optical code versions and ECC levels, to determine a probability that a given frame will be properly detected and decoded for a plurality of different optical code versions. It is possible to run such testing for all available combinations of optical code version and ECC level, but this is not necessarily required, and testing can be limited to only candidate combinations of optical code version and ECC level which are of particular interest. The results of this evaluation can be provided to the sequence generator component or another component which determines the optimal optical code version to use for a communication.

In act 1810, based on the probability of proper detection and decoding, a completion time for transfer of a sequence of optical codes can be calculated. Each calculation of a completion time in act 1810 can include acts 1811, 1812, 1813, 1814, and 1815 for the given optical code version. Stated differently, average, minimum, or expected read time of an optical code sequence can be determined by running a simulation for a candidate optical code version and ECC level combination (candidate segmentation parameters).

In act 1811, for the given optical code version, the amount of time required to communicate the sequence of optical codes once is determined (i.e., the time to communicate a single playback loop of the optical sequence is determined). This could entail multiplying the length of each frame by the number of frames. For example, if a sequence of optical codes communicates each frame for 1/10 of a second, and there are 30 frames to communicate, then the time to communicate the sequence of optical codes once is three seconds. However, variable communication times for loop iterations can be accounted for, as will be discussed later.

In act 1812, a random determination is made as to whether each frame in the optical code sequence will be successfully decoded based on the probability of successful detection and decoding (i.e., the system does a simulation of a playback loop, to identify frames which are not properly detected and decoded).

In act 1813, a determination is made as to whether there are any frames in the sequence which have not yet been successfully decoded. In this case, the simulation of the first playback loop determines whether any of the frames of the sequence were not successfully decoded during the first playback loop. If there is at least one frame which has not been not successfully decoded yet, the method proceeds to act 1814.

In act 1814, a random determination is made as to whether for another playback loop (second playback loop in this case), each frame in the sequence which has not yet been successfully decoded will be successfully decoded based on the probability of successful detection and decoding. That is, in act 1814 a determination is made as to whether, among the previously non-decoded frames, there are any frames still not properly decoded. The method then proceeds back to act 1813, where a determination is made as to whether, even after the second playback loop, there are any frames which have not yet been successfully decoded. Importantly, it is not required that all frames be properly decoded within a single loop for act 1813 to identify that there are no frames which have not yet been decoded. Rather, act 1813 determines whether there are any frames which have not been successfully decoded in any previous playback loop. As long as there is at least one non-decoded frame in the sequence, the method can cycle between acts 1813 and 1814 to run successive playback loops.

Once a determination is made in act 1813 that there are no non-decoded frames in the sequence, the method proceeds to act 1815. In act 1815, the completion time for communication of the sequence for the given optical code version is determined, based on the number of playback loops that were need to completely decode the optical sequence. Since the full sequence is sent by the sending device even if only a single frame remains to be decoded, the completion time could be determined by multiplying the number of loops needed by the time required to communicate the sequence once as determined in act 1811. In implementations where the playback speed (and thus playback time) of each loop changes with each successive loop, as discussed earlier, act 1811 can entail determining the playback time for each loop, and the completion time can be obtained in act 1815 by summing the time of each playback loop which was required to complete decode the sequence.

The acts within act 1810 can be performed for each optical code version and ECC level combination of interest, to obtain a completion time for each such optical code version and ECC level combination. Further, to account for the probabilistic nature of the simulation, the acts within act 1810 can be performed multiple times for each optical code version and ECC level combination, and averaged or otherwise combined to increase accuracy of the simulation (e.g. by obtaining an average completion time for each optical code version and ECC level combination). In act 1820, based on the calculated completion times, the optical code version and ECC level combination that produces the lowest completion time can be selected as the optimal optical code version and ECC level combination.

The discussed simulations are useful to determine which optical code version and ECC level results in an optimal total time for completion and the probability of that occurring based on the results of many simulations (e.g. 100 simulations per combination of version and ECC).

Although the acts of method 1800 in FIG. 18 are shown as being completed in a certain order, acts can be removed, added, or reordered as appropriate for a given application. For example, act 1811 does not need to be performed before act 1812; instead, act 1811 could be performed immediately before act 1815.

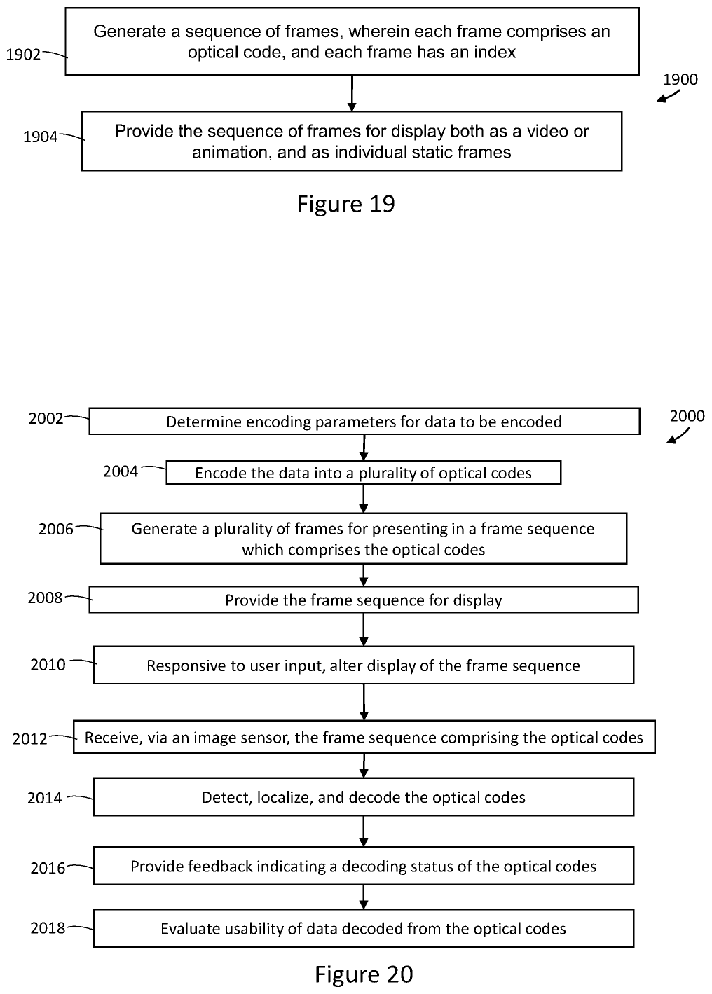

FIG. 19 is a flowchart diagram which illustrates an exemplary method 1900 for generating and providing a sequence of frames. Method 1900 includes at least acts 1902 and 1904, but additional acts could be included as appropriate for a given application.

In act 1902, a sequence of frames is generated by a sequence generator, wherein each frame comprises an optical code and each frame has an index. For example, a processor communicatively coupled to but not physically included in a sending device could generate the sequence of frames. As another example, a processor included in the sending device could generate the sequence of frames.

In act 1904, the sequence of frames is provided for display both as a video or animation, and as individual static frames. For example, the sequence generator could provide the sequence of frames to the sending device as a GIF, AVI, MPG, or other appropriate video or animation file type. The sequence generator can also provide the sequence of frames to the sending device as a plurality of image files, such as BMP, PNG, JPG, or any other appropriate format. By providing the sequence of frames in both video/animation format and static image format, the sending device has the flexibility to display either format of the sequence of frames, based on what formats the sending device is configured to display. Additionally or alternatively, the sending device could display the video/animation formatted sequence of frames when the whole sequence is being communicated, and can display the static image for a given frame when said frame is displayed independently (such as discussed above with reference to FIG. 13).

Communicating data from a sending device to a receiving device via a sequence of optical codes has several benefits. For example, the amount of data that can be transmitted greatly exceeds what is possible with a single optical code (for example, a sequence of 100 codes can transmit 100 times more data than a single code). Further, no radio frequency based network connectivity is required for data transmission (i.e. sending and receiving devices are “air gapped” and communicate using optical frequencies in the visible light range, display screen to camera).

Some exemplary applications benefiting from the advantages of optical code sequences include: a) Digital identification; b) Diagnostics; c) Medical devices, and d) Medical records (e.g. vaccination status).

In one example, a sequence of optical codes is used to represent an individual's identity. The sending device may be the individual's smart phone. Receiving devices could be any device that requires confirming the individual's identify (for example, a passport kiosk or terminal at an airport). The data encoded may contain alphanumeric information about the individual (e.g. name, date of birth, etc). The data encoded may also include biometric information about the individual. For example, information describing the individual's fingerprints may be encoded (a variety of encoding methods being available for such data, including bitmaps, 2D coordinates, shape model coefficients, etc.). Other biometric markers may similarly be encoded (e.g. retina scans, face identification, etc.).

In one example, an optical code sequence from a sending device communicates information about the individual (e.g. their credit card number), as well as their biometric information to a receiving device. The receiving device may be configured to receive the information, and also receive a biometric measurement from the individual. The receiving device may compare the biometric measurement and the biometric information from the optical code sequence to perform authentication (for example, a credit card payment may require authentication before processing).

In a similar example, the sending device may be coupled to biometric sensors (e.g. the finger-print sensor on a smartphone); the sending device may generate a biometric measurement and encode it into the optical code sequence for transmittal to a receiving device. The receiving de-vice may validate the biometric information without the need of having biometric sensing capability.

In the above examples, written and/or digital signatures may be contemplated instead of or in addition to the biometric information.

In an example, the optical code sequence encodes digitally signed data using key pairs that provides certification of the data by an authority that issued the data. If a sender is to send information as proof of a fact (whether it is identity alone or identity and other information like a vaccination status), it may be desired that all of this data is signed by a third party issuer of the data such as a government authority, an institution, etc.). In this way, the vaccine proof can't be spoofed.

In an embodiment, the issuer (e.g. a public authority) compiles data for an individual and signs it with a private key. This signed data and the signature is encoded in optical codes and provided to the respective individual. The authority's public key is made available (e.g. as a digital certificate) to all for storing on a code receiving device that wants to confirm data received is proper and has not been subject to tampering. An individual provides the optical codes encoding the signed data to a receiving device as proof of the fact sought to be proved. The receiving device decodes the optical codes to get the signed data and signature uses the public key to confirm the data received was certified (signed) by the issuer authority using common practices.

While described with reference to a public authority, data to be encoded in the optical codes (all or part) may be signed by any entity in an applicable scenario (e.g. a manufacturer providing diagnostic data, a physician or health care provider providing medical data, etc. as described).

In one example, an individual's medical records, for example, their vaccination history, is encoded and provided by a sending device as an optical code sequence. Such medical information is well suited for the application of optical codes sequences because no network connectivity is needed (beneficial for cybersecurity and the safeguarding of privacy), and because the quantity of information required to describe medical information may be greater than what is available on static optical codes.

As discussed, medical devices may benefit from receiving data via optical code sequences, for the purposes of increased privacy and cybersecurity. For example, transferring pre-operative surgical planning information to intra-operative surgical devices.

Diagnostic information may benefit from being transmitted via optical code sequences. Large amounts of numerical data may be transmitted in an optical code sequence. For example, in automotive applications, vehicle diagnostics are typically available over a physical connector to a specialized receiving device. In this application, the vehicle itself may provide the sending device (e.g. the main dashboard display), and the receiving device may be a smartphone; vehicle diagnostics may be available on the smartphone without the need for specialized diagnostic equipment or connectors.

Applications in which the receiving device has limited electrical power may benefit from receiving data via optical code sequences. For example, where the receiving device is battery operated, and where changing batteries often is impractical. The receiving device may implement a simple user interface to minimize power consumption. For example, the user interface may consist of LEDs that indicate the optical code reading status to a user. For example: LED flashing may indicate “currently reading code sequence”; red LED may indicate a failure to read the code; Green LED may indicate success, and so on. In another example, a progress bar may be indicated via the flashing frequency of the LED (i.e. flashing frequency may be proportional to percentage progress).

Several exemplary implementations and embodiments are described above. It is within the scope of the present disclosure to combine features and aspects of each implementation and embodiment together; however, not all features of each embodiment or implementation are necessarily required. FIG. 20 is an exemplary flowchart diagram which illustrates how several embodiments discussed herein can be used in combination. FIG. 20 illustrates method 2000, which includes acts 2002, 2004, 2006, 2008, 2010, 2012, 2014, 2016, and 2018. The acts of method 2000 can be rearranged or reordered, and acts of method 2000 can be removed, or new acts could be added, within the scope of the present disclosure. Unless required otherwise, the acts of method 2000, and examples of said acts discussed below, can be optional.

In act 2002, encoding parameters are determined for data to be encoded. This could be achieved for example using methods 1700 and 1800 in FIGS. 17 and 18. In some examples, such encoding parameters could be determined as part of an encoding process, shortly before encoding. In other examples, encoding parameters could be determined during configuration of a system in advance of an encoding process.

In act 2004, the data is encoded into a plurality of optical codes. This can be based on encoding parameters determined in act 2002, to encode the data into an appropriate plurality of optical codes (or an optical code sequence). This could also entail encoding primary data and secondary data, as discussed with reference to FIGS. 14 and 15.

In act 2006, a plurality of frames are generated for presenting in a frame sequence which comprises the optical codes. For example, the plurality of optical codes could be arranged sequentially in the frame sequence, with one optical code in each frame. In some examples, a plurality of optical code channels can be arranged in each frame, similar to as discussed with reference to FIGS. 2A-2B, 3A-3B, 4A-4C, 5A-5B, and 6A-6B. The plurality of frames could be formatted as a video or animation file (such as a GIF, AVI, MPG or similar), and/or as a collection of static images (such as BMP, PNG, JPG, or similar), as discussed with reference to FIG. 19, for example.

In act 2008, the frame sequence is provided for display, for example as shown in FIG. 1. In some examples, a sequence generator included in a sending device can provide the frame sequence to a display element of the sending device, and the display element can display the sequence of frames. In other examples, a sequence generator external to the sending device can provide the sequence of frames to the sending device, and the sending device can display the sequence of frames.

In act 2010, responsive to user input, the sending device can alter display of the sequence of frames. Exemplary inputs and alterations of display based thereon are described with reference to FIGS. 12 and 13.

In act 2012, a receiving device receives, via an image sensor, the sequence of frames comprising the optical codes, for example as shown in FIG. 1.

In act 2014, the receiving device (or a decoder communicatively coupled thereto) detects, localizes, and decodes the optical codes. Exemplary techniques for detecting and localizing optical codes are discussed with reference to FIGS. 7, 8A-8D, and 9A-9B. Decoding failures can result in the sequence of frames being received multiple times (e.g. on loop), as discussed for example with reference to FIGS. 3B and 16A-16F. Any of the properties of such loops discussed herein can be applied in the context of method 2000, with one example including variable loop playback speed.

In act 2016, feedback is provided indicating a decoding status of the optical codes. Exemplary techniques and feedback interfaces are described with reference to FIGS. 10, 11A-11B, and 16A-16F.

In act 2018, usability of data decoded from the optical codes can be evaluated. Exemplary evaluation techniques are described with reference to FIGS. 14 and 15.

Many of the methods and systems described herein can be implemented across a network, as is discussed with reference to FIGS. 21A and 21B below.

FIG. 21A is an illustration of a computer network system 2100 in accordance with an exemplary embodiment. System 2100 comprises a sending device 2102 and a user 2104. The sending device is coupled to a network 2106, for example a wired and/or wireless network which may be public and/or private. In some implementations, the network 2106 may be, or may be communicatively coupled to, the Internet.

Also shown are additional computing devices 2108 and 2110 coupled to the network. Computing device 2108 is a data originating device to define data for encoding into frames comprising optical codes. Computing device 2110 is a sequence generating device configured to receive data to be encoded and generating the frames comprising the optical codes. Computing device 2110 can communicate the frames to sending device 2102, for example, as a video or animation file such as a GIF, AVI, MPG, or similar, and/or as static images of the optical codes. Sending device 2102 comprises a display device with which to display the optical codes.

Sending device 2102 can have any of the sending functionality and features described herein.

Computing device 2110 can have any of the sequence generator functionality and features described herein, including without limitation data segmentation, optical code encoding and frame sequence generating functionality.

In some implementations, the sending device 2102 communicates over the network 2106 with computing device 2110 to provide information on physical specifications of sending device 2102 (e.g. screen size, resolution, framerate). Computing device 2110 may use this information to determine ideal sequence characteristics (e.g. Optical Code version, ECC level, sequence frames per second), as is described in detail with reference to FIG. 18.

FIG. 21B is an illustration of a computer network system 2150 in accordance with an embodiment comprising sending device 2102 operated by user 2104 and a receiving device 2152 operated by a user 2154. Receiving device 2152 comprises (e.g. on board or coupled thereto) a camera or image sensor 2156. In an embodiment, computer network system 2150 is established in an operating room to transfer data for a surgical procedure to an intraoperative computing device 2152 defining the receiving device.

Sending device 2102 and receiving device 2152 are configured to communicate optical codes from the sending device 2102 to the receiving device 2152 over a distance, without radio waves. Sending device 2102 can have any of the sending functionality and features described herein, including without limitation frame displaying functionality. Receiving device 2152 can have any of the receiving, detecting, localizing, and decoding functionality and features described herein, including without limitation, progress indicator features set out with reference to FIGS. 16A-16F.

In another embodiment, not shown, features and functions of computing device 2108 and 2110 are provided by a single computing device.

The various computing devices shown herein comprise a processing unit (for example a microprocessor, FPGA, ASIC, logic controller, or any other appropriate processing hardware), a storage device (e.g. non-transitory processor-readable storage medium, such as memory, RAM, ROM, magnetic-disk, solid state storage, or any other appropriate storage hardware) storing instructions which when and executed by the processing unit configure the computing device to perform operations for example to provide the functionality and features described herein. Computer program code for carrying out operations may be written in any combination of one or more programming languages, e.g., an object oriented programming language such as Java, Smalltalk, C++ or the like, or a conventional procedural programming language, such as the “C” programming language or similar programming languages.

Any of the computing devices may have communication subsystems to communicate via a network such as network 2106. Any may have a display device and other input and/or output devices. At least device 2152 has an image sensor, such as a camera. Device 2102 is preferably a mobile device such as a smartphone, tablet, laptop etc. but the devices may have any form factor.

Practical implementation may include any or all of the features described herein. These and other aspects, features and various combinations may be expressed as methods, apparatus, systems, means for performing functions, program products, and in other ways, combining the features described herein. A number of embodiments have been described. Nevertheless, it will be understood that various modifications can be made without departing from the spirit and scope of the processes and techniques described herein. In addition, other steps can be provided, or steps can be eliminated, from the described process, and other components can be added to, or removed from, the described systems. Accordingly, other embodiments are within the scope of the following claims.

Throughout the description and claims of this specification, the word “comprise”, “contain” and variations of them mean “including but not limited to” and they are not intended to (and do not) exclude other components, integers or steps. Throughout this specification, the singular encompasses the plural unless the context requires otherwise. In particular, where the indefinite article is used, the specification is to be understood as contemplating plurality as well as singularity, unless the context requires otherwise.

Features, integers, characteristics, or groups described in conjunction with a particular aspect, embodiment or example are to be understood to be applicable to any other aspect, embodiment or example unless incompatible therewith. All of the features disclosed herein (including any accompanying claims, abstract and drawings), and/or all of the steps of any method or process so disclosed, may be combined in any combination, except combinations where at least some of such features and/or steps are mutually exclusive. The invention is not restricted to the details of any foregoing examples or embodiments. The invention extends to any novel one, or any novel combination, of the features disclosed in this specification (including any accompanying claims, abstract and drawings) or to any novel one, or any novel combination, of the steps of any method or process disclosed.

1. A computer method comprising:
generating a plurality of frames for presenting in a frame sequence, wherein:
data is encoded into a plurality of optical codes in an optical code sequence;
the plurality of frames comprises at least two channels to present the optical code sequence; and
each channel presents the same optical codes in the optical code sequence, but in a different order of the optical code sequence; and
providing the frame sequence for display.

2. The method of claim 1, wherein the different order of the codes is selected to optimize a combination of: transmission duration and transmission predictability.

3. The method of claim 1, further comprising generating identification features to visually identify and distinguish the at least two channels.

4. The method of claim 1, wherein the frames are generated as components of a video file or a GIF.

5. The method of claim 1, wherein providing the frame sequence for display comprises communicating the frames to a sending device configured to display the frames for receiving by a receiving device at a distance from the sending device, without using radio waves to communicate the frames between the sending device and the receiving device.

6. A computer method comprising:
a. receiving, via an image sensor, a sequence of images from a sending device displaying frames in a frame sequence comprising at least two channels of optical codes;
b. identifying, from the images, optical codes from each of the at least two channels;
c. decoding and storing the identified optical codes, wherein duplicate optical codes are discarded; and
d. performing steps a, b and c until a completeness metric is achieved.

7. The method of claim 6, wherein identifying the optical codes from each channel comprises localizing a respective optical code in a respective image using image processing.

8. The method of claim 7, wherein localizing comprises determining a location of identification features in the respective image.

9. The method of claim 6, wherein localizing is based on a location of identified optical codes in a previous image to the respective image.

10. The method of claim 6, wherein the optical codes are defined having a code sequence and wherein, in the frames, each channel comprises the same optical codes but in a different order of the code sequence, wherein the different order of the code sequence is selected to optimize a combination of: transmission duration and transmission predictability.

11. The method of claim 6, wherein receiving via the image sensor comprises receiving from a sending device the frames at a receiving device over a distance, without using radio waves to communicate the frames between the sending device and the receiving device.

12. A computer method comprising:
receiving, via an image sensor, a sequence of images from a sending device displaying frames comprising a sequence of optical codes, each optical code comprising an optical code index;
decoding the optical codes and recording optical code indices of the codes that are decoded; and
providing for display a progress indicator responsive to the optical code indices of the codes that are decoded.

13. The method of claim 12, further comprising providing for display a second indicator indicating a location of a last decoded optical code within the sequence of optical codes.

14. The method of claim 13, wherein the second indicator is one of:
a numerical display of a last read optical code index; or
a graphical indicator along a graphical element representing the sequence of optical codes.

15. The method of claim 12, wherein the progress indicator is one or both of:
a numerical display of indices of unread optical codes; or
a graphical element in which read and unread codes are visually distinguishable.

16. The method of claim 12, wherein each frame comprising a frame index, each frame comprising a plurality of optical codes of the optical code sequence, wherein providing for display a progress indicator includes providing for display a progress indicator which indicates at least one frame index of at least one frame containing an optical code that was not decoded.

17. The method of claim 12, wherein the progress indicator responsive to the optical codes indices indicates which indices have or have not been received and wherein the method further comprises:
providing for display a progress indicator of transmission time of the optical codes.

18. The method of claim 17, wherein the progress indicator is a countdown timer indicating an amount of time remaining to decode the optical codes.

19. The method of claim 18, wherein the countdown timer is responsive to each optical code remaining to be received and decoded without error.

20. The method of claim 18, wherein the countdown timer is responsive to a projected number of errors.

21. The method of claim 17, further comprising calculating the frequency of image transitions, wherein the countdown timer is responsive to the frequency as calculated.

24.-31. (canceled)
